(19) United States
(12) Patent Application Publication
(10) Pub. No.: US 2014/0298153 A1
(43) Pub. Date: Oct. 2, 2014

(54) IMAGE PROCESSING APPARATUS, CONTROL METHOD FOR THE SAME, IMAGE PROCESSING SYSTEM, AND PROGRAM

(71) Applicant: CANON KABUSHIKI KAISHA, Tokyo (JP)

(72) Inventors: Takuya Tsujimoto, Kawasaki-shi (JP); Tomochika Murakami, Ichikawa-shi (JP)

(73) Assignee: Canon Kabushiki Kaisha, Tokyo (JP)

(21) Appl. No.: 14/356,967

(22) PCT Filed: Dec. 6, 2012
(86) PCT No.: PCT/JP2012/082267

§ 371 Date: May 8, 2014

(30) Foreign Application Priority Data
Dec. 26, 2011 (JP) 2011-283721
Oct. 3, 2012 (JP) 2012-221557

(51) Int. Cl. G06F 17/24; G06F 3/0484; G06F 3/0487

(52) U.S. Cl. CPC G06F 17/241; G06F 3/0487; G06F 3/0484
USPC 715/232

(57) ABSTRACT

An image processing apparatus includes an obtaining unit obtaining data of an image of an object and data of a plurality of annotations attached to the image, an input unit receiving a designation of a display magnification for enlarging or reducing the image, and a generation unit generating display data with which the annotations are displayed in such a way as to be superimposed on the image enlarged at the designated display magnification, wherein the data of the plurality of annotations includes position information indicating a position in the image at which each annotation is attached and information about the display magnification of the image at the time of attachment of each annotation, and the generation unit generates display data with which display modes of annotations are made different between annotations of which the display magnifications of the image at the time of attachment thereof are different.

### TECHNICAL FIELD

The present invention relates to an image processing apparatus, a control method for the same, an image processing system, and a program.

### BACKGROUND ART

In the field of pathology, a virtual slide system that enables pathological diagnosis on a display apparatus by capturing an image of a sample to be examined (or specimen) placed on a slide and digitizing the image has been getting attention in recent years as a pathological diagnosis tool substituting an optical microscope. Digitizing of images for pathological diagnosis using the virtual slide system enables to handle conventional optical microscope images of specimens as digital data. Consequently, this system is expected to provide advantages such as speedup of remote diagnosis, explanation to patients using digital images, sharing of rare cases, enhanced efficiency in education and practice.

To make operability of a virtual slide system substantially same as that of an optical microscope, it is necessary that an image of a specimen in slide be digitized in its entirety. Digitization of an image of a specimen in its entirety enables visualization of digital data produced by a virtual slide system through viewer software running on a personal computer or a workstation. The number of pixels of a digitized image of a specimen in its entirety is normally several hundred millions or several billions, leading to a very large data amount. This very largeness of the data amount produced by a virtual slide system enables a variety of observation ranging from microscopic observation (of an enlarged image of a detail) to macroscopic observation (of an overall image) using enlarging and reducing by a viewer software, providing various conveniences. If all information needed has been obtained in advance, images can be immediately displayed at any resolution and any magnification desired by a user (i.e. as images ranging from low magnification images to high magnification images).

There have been developed an image processing apparatus which attaches, when obtaining a medical image (imaged by ultrasonic imaging), an annotation to the medical image and searches for the medical image using a comment in the annotation as a search key (Patent Literature 1).

There have been developed an information processing apparatus in which a display magnification and display position at the time when an annotation is attached to an electronic document are held, and the electronic document is displayed on a screen based on the display magnification and display position thus held (Patent Literature 2).

### CITATION LIST

### Patent Literature

PTL 1: Japanese Patent Application Laid-Open No. 11-353327
PTL 2: Japanese Patent Application Laid-Open 2010-61311

### SUMMARY OF INVENTION

### Technical Problem

In cases where an annotation is attached to a virtual slide image, it is difficult for a user to know the magnification of the virtual slide image at the time of attachment of the annotation (i.e. the magnification of the virtual slide image at the time when the annotation was attached to it). In other words, it is difficult for the user to know the difference between the magnification of the image he/she is observing and the magnification the image at the time when the annotation was attached to it. Furthermore, in cases where the magnification at the time of attachment varies among a plurality of annotations, it is difficult for the user to know the difference between the magnification at the time of attachment of each annotation and the magnification of the image he/she observes.

This is also the case when the virtual slide image is a depth image (z-stack image), namely it is difficult for the user to know the focus position (z position) of the virtual slide image at the time of attachment of an annotation (i.e. the focus position of the virtual slide image at the time when an annotation was attached to it). In other word, it is difficult for the user to know the difference between the focus position of the image he/she observes and the focus position at the time when the annotation was attached to the image. Furthermore, in cases where the focus position at the time of attachment varies among a plurality of annotations, it is difficult for the user to know the difference between the focus position at the time of attachment of each annotation and the focus position of the image he/she observes.

In view of the above situations, an object of the present invention is to enable users to easily know the magnification and/or the focus position of a virtual slide image at the time of attachment of an annotation, when displaying the annotation.

### Solutions to Problem

According to one aspect of the present invention, there is provided an image processing apparatus comprising:

an obtaining unit configured to obtain data of an image of an object and data of a plurality of annotations attached to the image;

an input unit configured to receive a designation of a display magnification for enlarging or reducing the image; and

a generation unit configured to generate display data with which the annotations are displayed in such a way as to be superimposed on the image enlarged at the designated display magnification,

wherein the data of the plurality of annotations includes position information indicating a position in the image at which each annotation is attached and information about the display magnification of the image at the time of attachment of each annotation, and

the generation unit generates display data with which display modes of annotations are made different between annotations of which the display magnifications of the image at the time of attachment thereof are different.

According to another aspect of the present invention, there is provided an image processing apparatus comprising:

an obtaining unit configured to obtain data of an image of an object including data of a plurality of depth images obtained by imaging the object at different focus positions with respect to the direction of an optical axis, and data of a plurality of annotations attached to the image;

an input unit configured to receive a designation of a focus position; and

a generation unit configured to generate display data with which the annotations are displayed in such a way as to be superimposed on a depth image of the designated focus position,

wherein the data of the plurality of annotations includes position information indicating a position in the image at which each annotation is attached and information about the focus position of the image at the time of attachment of each annotation, and

the generation unit generates display data with which display modes of annotations are made different between annotations of which the focus positions of the image at the time of attachment thereof are different.

According to still another aspect of the present invention, there is provided a method of controlling an image processing apparatus comprising:

an obtaining step of obtaining data of an image of an object and data of a plurality of annotations attached to the image;

an input step of receiving a designation of a display magnification for enlarging or reducing the image; and

a generation step of generating display data with which the annotations are displayed in such a way as to be superimposed on the image enlarged at the designated display magnification,

wherein the data of the plurality of annotations includes position information indicating a position in the image at which each annotation is attached and information about the display magnification of the image at the time of attachment of each annotation, and

in the generation step, generating of display data with which display modes of annotations are made different between annotations of which the display magnifications of the image at the time of attachment thereof are different is performed.

According to still another aspect of the present invention, there is provided a method of controlling an image processing apparatus comprising:

an obtaining step of obtaining data of an image of an object including data of a plurality of depth images obtained by imaging the object at different focus positions with respect to the direction of an optical axis, and data of a plurality of annotations attached to the image;

an input step of receiving a designation of a focus position;

a generation step of generating display data with which the annotations are displayed in such a way as to be superimposed on a depth image of the designated focus position,

wherein the data of the plurality of annotations includes position information indicating a position in the image at which each annotation is attached and information about the focus position of the image at the time of attachment of each annotation, and

in the generation step, generating of display data with which display modes of annotations are made different between annotations of which the focus positions of the image at the time of attachment thereof are different is performed.

### Advantageous Effects of Invention

According to the present invention, when an annotation is displayed, a user can readily know the magnification and/or the focus position of a virtual slide image at the time when the annotation was attached.

Further features of the present invention will become apparent from the following description of exemplary embodiments with reference to the attached drawings.

### BRIEF DESCRIPTION OF DRAWINGS

FIG. 1 is an overall view showing the configuration of apparatuses in an image processing system according to an embodiment.

FIG. 2 is a functional block diagram of an imaging apparatus in the image processing system according to the embodiment.

FIG. 3 is a functional block diagram of the image processing apparatus according to the embodiment.

FIG. 4 is a diagram showing the hardware configuration of the image processing apparatus according to the embodiment.

FIG. 5 is a diagram illustrating the concept of image layers prepared in advance for different magnifications respectively.

FIG. 6 is a flow chart of a process of attaching and presenting annotations.

FIG. 7 is a detailed flow chart of a process of attaching annotations.

FIG. 8 is a detailed flow chart of a process of presenting annotations.

FIGS. 9A to 9F show examples of the display screen in the image processing system according to the present invention.

FIG. 10 is an overall view showing the configuration of apparatuses in an image processing system according to a second embodiment.

FIGS. 11A and 11B are diagrams illustrating the concept of depth images prepared in advance for different focus positions respectively according to the second embodiment.

FIG. 12 is a flow chart of a process of attaching annotations in the second embodiment.

FIG. 13 is a flow chart of a process of presenting annotations in the second embodiment.

FIG. 14 is a flow chart of a process of controlling display of annotation data according to a third embodiment.

FIG. 15 is a flow chart of a process of controlling display of annotation data according to a fourth embodiment.

FIGS. 16A to 16C are one-dimensional schematic diagrams showing examples of depth image data in the third and fourth embodiments.

### DESCRIPTION OF EMBODIMENTS

In the following, embodiments of the present invention will be described with reference to the accompanying drawings.

### First Embodiment

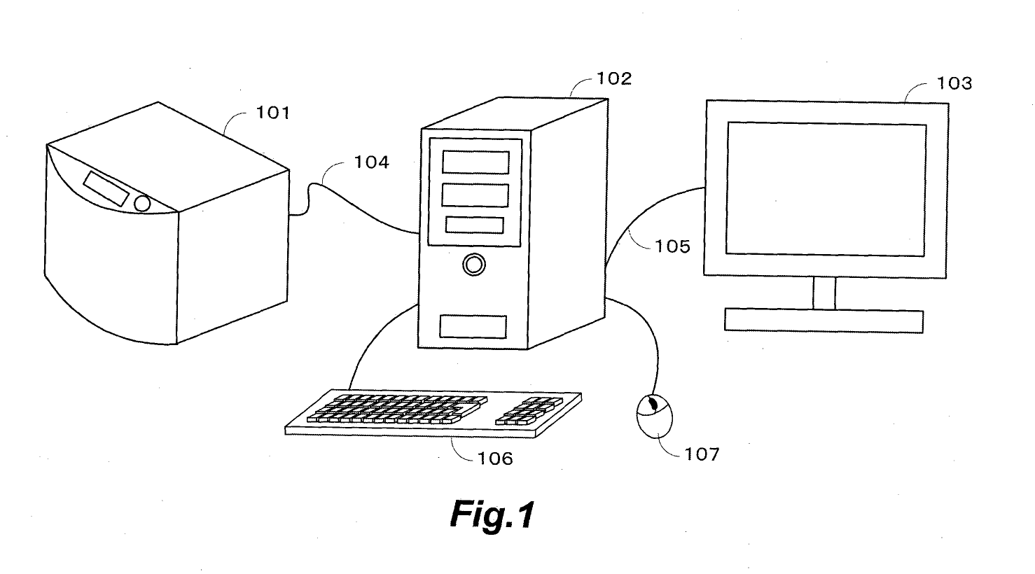

The image processing apparatus according to the present invention can be used in an image processing system including an imaging apparatus and a display apparatus. Such an image processing system will be described with reference to FIG. 1.

### (Configuration of Image Processing System)

FIG. 1 shows an image processing system using an image processing apparatus according to the present invention. The image processing system includes an imaging apparatus (microscope apparatus or virtual slide scanner) 101, an image processing apparatus 102, and a display apparatus 103. The image processing system has the function of capturing a two-dimensional image of a specimen (sample to be examined, or object) as an object of imaging and the function of displaying the two-dimensional image. The imaging apparatus 101 and the image processing apparatus 102 are connected by a special-purpose or general-purpose I/F cable 104, and the image processing apparatus 102 and the display apparatus 103 are connected by a general-purpose I/F cable 105.

The imaging apparatus 101 may be a virtual slide apparatus having the function of capturing a plurality of two-dimensional images that are different from each other in the position with respect to directions in a two-dimensional plane and in the position with respect to the depth direction perpendicular to the two-dimensional plane and the function of outputting digital images. A solid state imaging element such as a CCD (Charge Coupled Device) or CMOS (Complementary Metal Oxide Semiconductor) is used to capture two-dimensional images. The imaging apparatus 101 may include, in place of the virtual slide apparatus, a digital microscope apparatus composed of a normal optical microscope and a digital camera attached to the eyepiece portion of the digital camera.

The image processing apparatus 102 is an apparatus having the function of producing display data for display on the display apparatus 103 from data of a plurality of captured images obtained from the imaging apparatus 101, in response to a request by a user. The imaging apparatus 102 is a general-purpose computer or workstation having hardware resources including a CPU (Central Processing Unit), RAM, storage device, and various interfaces (I/F) including operation units. The storage device is a large capacity information storage such as a hard disk drive, in which programs and data for implementing various processing described later and an operating system (OS) are stored. The above-described functions are implemented in the CPU by loading a necessary program(s) and data from the storage device to the RAM and executing the program(s). The operation units include a keyboard 106 and a mouse 107, which are used by an operator to enter various commands.

The display apparatus 103 is a display such as a CRT or liquid crystal display on which a result of processing by the image processing apparatus 102 is displayed as an image to be observed.

While in the illustrative case shown in FIG. 1, the image processing system is composed of three apparatuses including the imaging apparatus 101, the image processing apparatus 102, and the display apparatus 103, the configuration of the system according to the present invention is not limited to this. For example, an image processing apparatus integrated with a display apparatus may be used, or the function of the image processing apparatus may be incorporated in the imaging apparatus. Alternatively, the functions of the imaging apparatus, the image processing apparatus, and the display apparatus may be implemented in one apparatus. Conversely, the function of the image processing apparatus or other apparatus may be distributed to a plurality of apparatuses.

### (Functional Configuration of Imaging Apparatus)

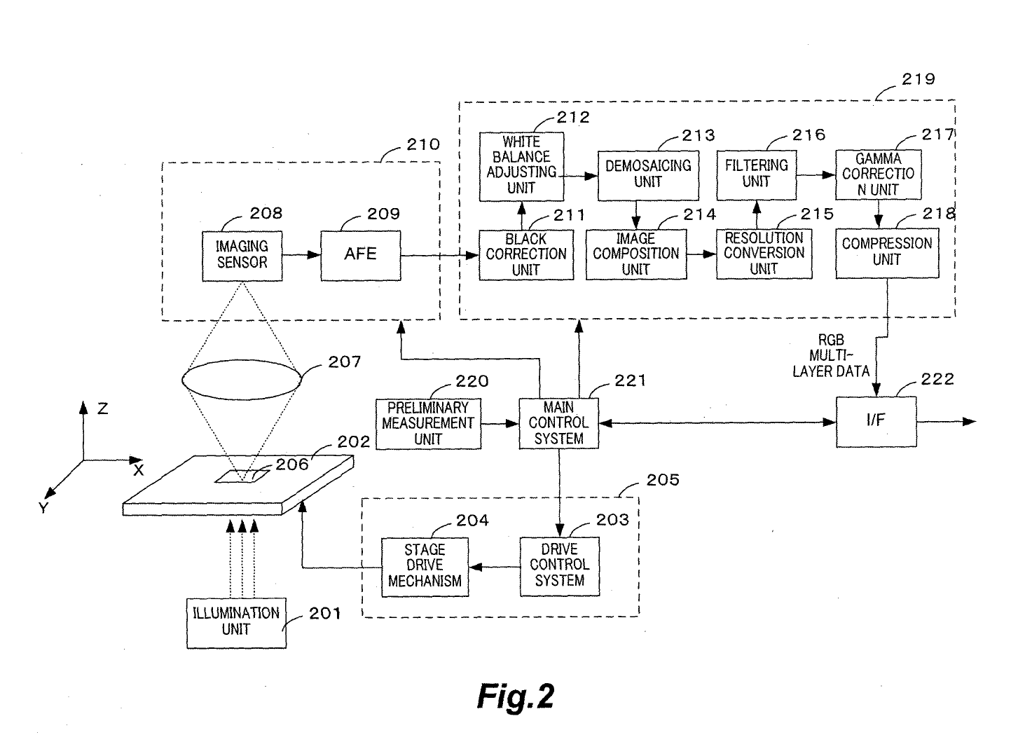

FIG. 2 is a block diagram showing the functional configuration of the imaging apparatus 101.

The imaging apparatus 101 includes, basically, an illumination unit 201, a stage 202, a stage control unit 205, an imaging optical system 207, an imaging unit 210, a developing unit 219, a preliminary measurement unit 220, a main control system 221, and a data output unit 222.

The illumination unit 201 is a unit uniformly illuminating a slide 206 set on the stage 202 with light. The illumination unit 201 includes a light source, an illumination optical system, and a control system for driving the light source. The stage 202 is driven under control by the control unit 205 so as to be able to shift in three axial directions or the X-axis, Y-axis, and Z-axis directions. The slide 206 is a piece made by attaching a thin slice of tissue or cell smear as an object to be observed on a slide glass and fixing it under a cover glass with mounting agent.

The stage control unit 205 includes a drive control system 203 and a stage drive mechanism 204. The drive control system 203 receives instructions from the main control system 221 to perform drive control for the stage 202. The direction of shift and the amount of shift of the stage 202 are determined based on position information and thickness information (or distance information) of specimen obtained by measurement by a preliminary measurement unit 220 and on a command input by the user if needed. The stage drive mechanism 204 drives the stage 202 in accordance with instructions from the drive control system 203.

The imaging optical system 207 is a lens unit for forming an optical image of the specimen in the slide 206 on an imaging sensor 208.

The imaging unit 210 includes the imaging sensor 208 and an analogue front end (AFE) 209. The imaging sensor 208 is a one-dimensional or two-dimensional image sensor 208 such as a CCD or CMOS device that converts a two-dimensional optical image into a physical quantity (i.e. electrical quantity) by photoelectric conversion. In the case where the imaging sensor 208 is a one-dimensional sensor, a two-dimensional image is obtained by scanning along a scanning direction. The imaging sensor 208 outputs an electrical signal having a voltage value correlating with the light intensity. In the case where a color image is needed to be captured, a single image sensor to which a color filter having a Bayer arrangement is attached may be used for example. In the imaging unit 210, the stage 202 is driven along the X axis direction and the Y axis direction to capture divisional images of a specimen.

The AFE 209 is a circuit that converts an analog signal output from the imaging sensor 208 into a digital signal. The AFE 209 includes an H/V driver described later, a CDS (Correlated Double Sampling), an amplifier, an AD converter, and a timing generator. The H/V driver converts a vertical synchronizing signal and a horizontal synchronizing signal for driving the imaging sensor 208 into voltages required to drive the sensor. The CDS is a correlated double sampling circuit for removing fixed pattern noises. The amplifier is an analog amplifier that adjusts the gain of the analog signal from which noises have been removed by CDS. The AD converter converts the analog signal into a digital signal. In the case where the output resolution of the final stage of the imaging apparatus is 8 bits, the AD converter converts the analog signal into digital data quantized generally in 10 to 16 bits in view of processing in a later stage and outputs it. The sensor output data after the conversion is referred to as RAW data. The RAW data is developed later in a developing unit 219. The timing generator generates a signal for adjusting the timing of the imaging sensor 208 and the timing of the developing unit 219 in a later stage.

While in the case where a CCD is used as the imaging sensor 208, the above-described AFE 209 is indispensable, in the case where a CMOS image sensor capable of outputting digital signals is used, the above-described function of the AFE 209 is incorporated in the sensor. There is also provided an imaging controller that controls the imaging sensor 208, though not shown in the drawings. The imaging controller controls operations and operation timing of the imaging sensor 208. The imaging controller controls, for example, the shutter speed, frame rate, and ROI (Region Of Interest) etc.

The developing unit 219 includes a black correction unit 211, a white balance adjusting unit 212, a demosaicing unit 213, an image composition unit 214, a resolution conversion unit 215, a filtering unit 216, a gamma correction unit 217, and a compression unit 218. The black correction unit 211 performs processing of subtracting black correction data obtained in the shaded state from the RAW data for each pixel. The white balance adjusting unit 212 performs processing of adjusting the gains of the respective colors of red, green, and blue in accordance with the color temperature of the light from the illumination unit 201 to reproduce desirable white. Specifically, white balance correction data is added to the RAW data after black correction. In the case where a monochromatic image is processed, the white balance adjusting processing is not needed. The developing unit 219 generates multi-layer image data, which will be described later, from divisional image data of a specimen captured by the imaging unit 210.

The demosaicing unit 213 performs processing of generating image data of respective colors of red, green, and blue from the RAW data of the Bayer arrangement. The demosaicing unit 213 calculates the respective values of red, green, and blue in a target pixel by performing interpolation using the values in the pixels (including pixels of the same color and pixels of different colors) in the vicinity of the target pixel in the RAW data. The demosaicing unit 213 also performs correction processing (or interpolation) for defective pixels. In the case where the imaging sensor 208 does not have a color filter and captures monochromatic images, the demosaicing processing is not needed.

The image composition unit 214 performs processing of splicing or joining together image data obtained by the imaging sensor 208 in divided imaging areas to generate large size image data representing a desired imaging area. Since the area over which a specimen extends is generally larger than the area over which existing image sensors can capture an image by one image capturing, a piece of two-dimensional image data is generated by splicing divisional pieces of image data together. For example, if a square area of 10 mm×10 mm on the slide 206 is to be imaged at a resolution of 0.25 μm, the number of pixels along one side is 10 mm/0.25 μm=40,000, and hence the total number of pixels is 40,000²=1,600,000,000. To obtain image data of 1,600,000,000 pixels using the imaging sensor 208 having 10M (10,000,000) pixels, it is necessary to divide the area into 160 divisional areas and to capture images in the respective divisional areas. Exemplary methods of splicing a plurality of pieces of image data include splicing with positional alignment based on information about the position of the stage 202, splicing while associating corresponding points or lines in a plurality of divisional images, and splicing based on positional information of divisional image data. Using interpolation processing such as 0-th order interpolation, linear interpolation, or high-order interpolation in splicing can make interpolation smoother. In this embodiment, it is assumed that a single image of large data amount is generated. However, the image processing apparatus 102 may have the function of splicing divisionally obtained images at the time of generating data for display.

The resolution conversion unit 215 performs processing of generating images having magnifications suitable for magnifications of image display by resolution conversion beforehand so that a two-dimensional image of large data amount generated by the image composition unit 214 can be displayed at high speed. The resolution conversion unit 215 generates data of images of a plurality of magnifications ranging from low magnification to high magnification and compose image data having a multi-layer structure in which the image data of a plurality of magnifications is packed.

The filtering unit 216 is a digital filter that reduces high frequency components contained in the image, removing noises, and increasing the apparent sharpness. The gamma correction unit 217 performs processing of giving inverse characteristics to the image taking into consideration tone reproduction characteristics of common display devices and performs tone conversion adapted to characteristics of human eyesight by tone compression in the high luminance range and/or image processing in the low brightness part. In this embodiment, in order to produce an image for morphological observation, tone conversion suitable for composition processing and display processing in later stages is applied to image data.

The compression unit 218 performs compression encoding in order to improve efficiency of transmission of large size two-dimensional image data and to reduce data amount for storage. As compression method for still images, standardized encoding system such as JPEG (Joint Photographic Experts Group), and JPEG2000 and JPEG XR developed by improving or advancing JPEG are widely known.

The preliminary measurement unit 220 is a unit that performs preliminary measurement in order to obtain by calculation information about the position of the specimen on the slide 206, information about the distance to a desired focus position, and a parameter associated with the thickness of the specimen for light quantity adjustment. By obtaining the information by the preliminary measurement unit 220 before image capturing, image capturing can be performed efficiently. A two-dimensional imaging sensor having a resolving power lower than the imaging sensor 208 is used to obtain position information in a two-dimensional plane. The preliminary measurement unit 220 determines the position of the specimen on the X-Y plane from a captured image. Furthermore, a laser displacement meter or a Shack-Hartmann sensor is used to obtain distance information and thickness information.

The main control system 221 has the function of controlling the units described in the foregoing. The control functions of the main control system 221 and the developing unit 219 are implemented in a control circuit having a CPU, ROM, and RAM. Specifically, programs and data are stored in the ROM, and the functions of the main control system 221 and the developing unit 219 are carried out by the CPU that executes the programs while using the RAM as a work memory. As the ROM, a device such as an EEPROM or flash memory is used. As the RAM, a DDR3 DRAM device is used for example. Alternatively, the function of the developing unit 219 may be implemented in an ASIC (Application Specific Integrated Circuit) as a dedicated hardware device.

The data output unit 222 is interface for transmission of the RGB color image generated by the developing unit 219 to the image processing apparatus 102. The imaging apparatus 101 and the image processing apparatus 102 are connected by an optical communication cable. Alternatively, general-purpose interface such as USB or Gigabit Ethernet (registered trademark) is used.

### (Functional Configuration of Image Processing Apparatus)

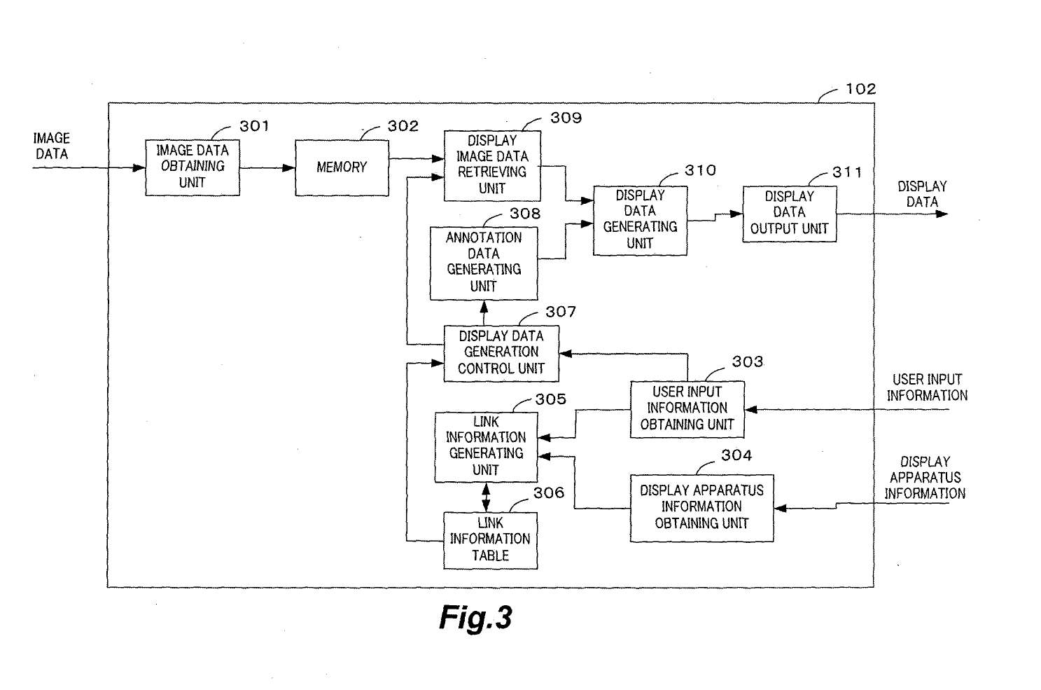

FIG. 3 is a block diagram showing the functional configuration of the image processing apparatus 102 according to the present invention.

The image processing apparatus 102 includes, basically, an image data obtaining unit 301, a memory 302, a user input information obtaining unit 303, a display apparatus information obtaining unit 304, a link information generating unit 305, a link information table 306, a display data generation control unit 307, an annotation data generating unit 308, an image data layer retrieving unit 309, a display data generating unit 310, and a display data output unit 311.

The image data obtaining unit 301 obtains image data captured by the imaging apparatus 101.

Image data obtained from an external apparatus is sent to the memory 302 through the image data obtaining unit 301 and stored in the memory 302. The image data stored in the memory 302 may be single two-dimensional image data obtained by joining RGB color divisional image data obtained by divisional imaging of a specimen. Alternatively, the image data stored in the memory 302 may be data of a plurality of images having different magnifications (multi-layer image data) or multi-layered image data composed of data of a plurality of images having different focus positions.

The user input information obtaining unit 303 obtains command information for changing the display state of a virtual slide image input by the user through an operation unit such as a mouse or a keyboard and attached annotation information. Examples of the command for changing the display state of a virtual slide image include scroll (changing the display position), enlarge/reduce (changing the display magnification), and rotate (changing the display angle). The annotation information includes information about a region of interest (or a focused-upon region) designated by the user and comment (or annotation) information.

The display apparatus information obtaining unit 304 obtains information about the size of the display area (such as the screen resolution and the number of pixels) and information about the magnification of the virtual slide image presently displayed from the display apparatus 103.

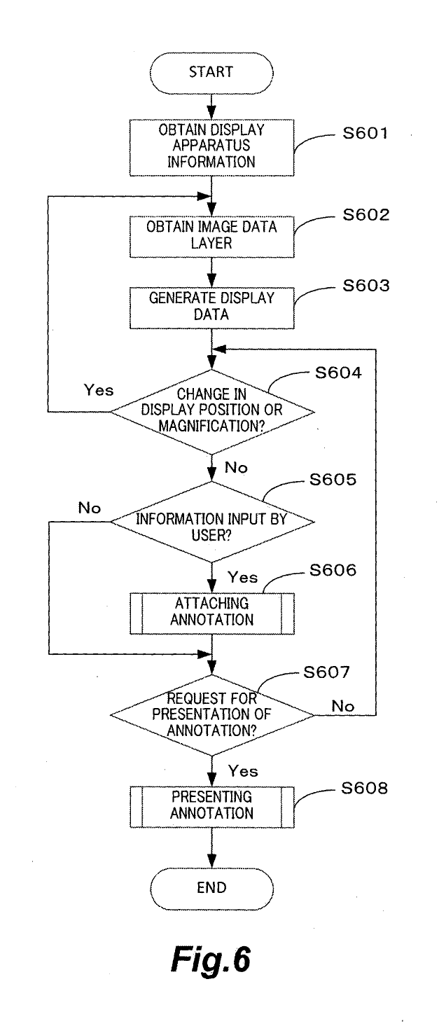

The link information generating unit 305 generates link information based on the position information of the annotation obtained through the user input information obtaining unit 303 and the display magnification of the virtual slide image at the time of attachment of the annotation obtained through the display apparatus information obtaining unit 304. The link information is information associating converted position information representing positions in the respective image data layers included in the image data corresponding to the position represented by the position information of the annotation with the magnifications of the respective image data layers. The link information is generated for each of the annotations attached to the image data. This process will be specifically described later with reference to FIG. 6.

The link information table 306 is a table storing the link information generated by the link information generating unit 305.

The display data generation control unit 307 controls the generation of display data based on a command for changing the display state of the virtual slide image and annotation information input by the user, pursuant to instructions from the user input information obtaining unit 303. The display data is mainly composed of virtual slide image data and annotation display data. The display data generation control unit 307 instructs the image data layer retrieving unit 309 to generate virtual slide image data and instructs the annotation data generating unit 308 to generate annotation display data.

The annotation data generating unit 308 generates annotation display data based on annotation information under control of the display data generation control unit 307.

The image data layer retrieving unit 309 retrieves an image data layer needed to display a virtual slide image from the memory 302 under control of the display data generation control unit 307.

The display data generating unit 310 generates display data to be displayed on the display apparatus 103 from the annotation display data generated by the annotation data generating unit 308 and the image data layer retrieved by the image data layer retrieving unit 309. The display data generating unit 310 generates a virtual slide image from the multi-layer image data according to a command for changing the display state input by the user and superimposes the annotation display data on it to generate the display data.

The display data output unit 311 outputs the display data generated by the display data generating unit 310 to the external display apparatus 103.

### (Hardware Configuration of Image Forming Apparatus)

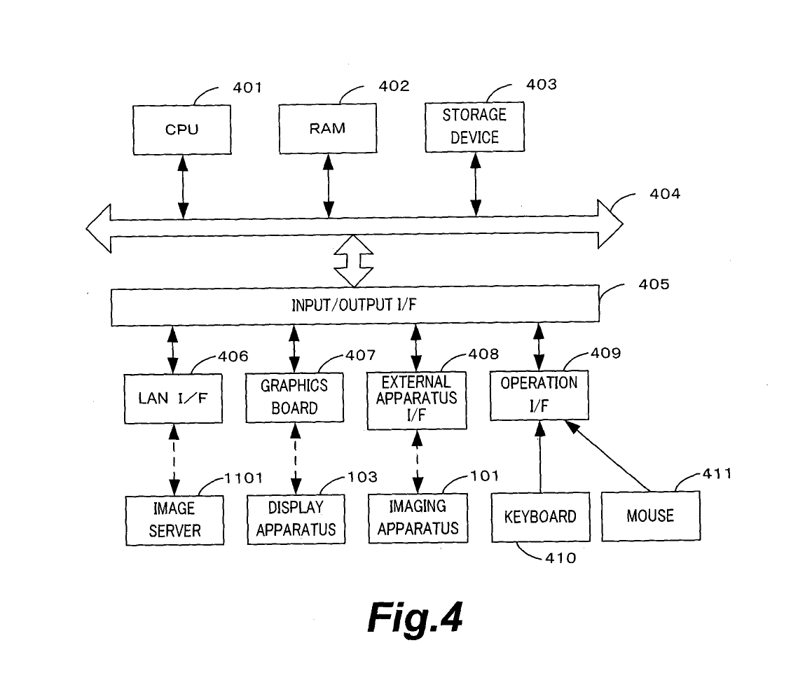

FIG. 4 is a block diagram showing the hardware configuration of the image processing apparatus according to the embodiment. For example, a personal computer (PC) is used as the image processing apparatus.

The image processing apparatus has a CPU (Central Processing Unit) 401, a RAM (Random Access Memory) 402, storage device 403, a data input/output interface (I/F) 405, and internal buses 404 that interconnect these blocks.

The CPU 401 accesses the RAM 402 etc when necessary and performs overall control of all the blocks in the personal computer while performing various calculation processing. The RAM 402 is used as a work space for the CPU 401 and temporarily stores the OS, programs under execution, and various data to which the display data generation processing etc. that characterizes the present invention is applied. The storage device 403 is an auxiliary storage device in/from which information can be stored/read out. The OS, programs, and firmware including various parameters to be executed by the CPU 401 are fixed and stored in the storage device 403. A magnetic disk such as a hard disk drive (HDD) or a solid state disk, (SDD) or a semiconductor device using a flash memory is used as the storage device 403.

To the data input/output interface 405, an image server 1101 is connected via a LAN interface 406, the display apparatus 103 is connected via a graphics board 407, and the imaging apparatus 101 is connected via an external apparatus interface 408. The imaging apparatus 101 is a virtual slide apparatus or a digital microscope. A keyboard 410 and a mouse 411 are connected to the data input/output interface 405 via an operation interface 409.

The display apparatus 103 is a display device using, for example, liquid crystal, electro-luminescence (EL), or cathode ray tube (CRT). While the display apparatus 103 is connected as an external apparatus to the image processing apparatus in this illustrative embodiment, the image processing apparatus according to the present invention may be integrated with a display apparatus, as is the case with a notebook PC.

While the keyboard 410 and the mouse 411 have been referred to as devices connected to the operation interface 409 by way of example, other input devices such as a touch panel may be connected thereto. In the case where a touch panel is used as an input device, the display apparatus 103 connected to the graphics board 407 and the input device connected to the operation interface 409 are integrated in one apparatus.

### (Concept of Multi-Layer Image Prepared for Multiple Magnifications)

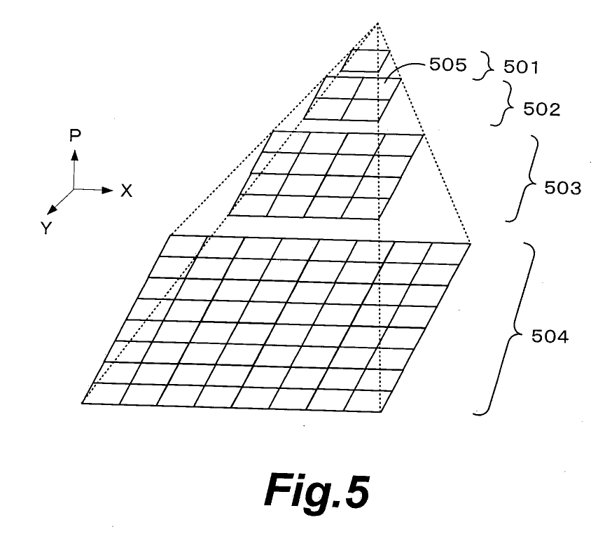

FIG. 5 schematically illustrates the concept of image data made up of a plurality of image data layers having different magnifications. Here, the multi-layer image data generated by the resolution conversion unit 215 of the imaging apparatus 101 shown in FIG. 2 will be described.

The image data layers 501, 502, 503, and 504 are two-dimensional image data having gradually different resolutions respectively prepared for corresponding display magnifications. In the illustrative case described here, it is assumed that the relationship between the resolutions (the numbers of pixels) along one-dimensional direction of the image data layers having different magnifications is as follows: the image layer 503 has a resolution equal to half that of the image layer 504; the image layer 502 has a resolution equal to half that of the image layer 503; and the image layer 501 has a resolution equal to half that of the image layer 502. The magnifications of prepared image data layers are not limited to those in the illustrative case shown in FIG. 5 but may be set arbitrarily.

The captured image data obtained by the imaging apparatus 101 is high resolution image data having several billions of pixels. If the resolution conversion processing for enlarging or reducing is performed each time a request for changing the display magnification of the virtual slide image is made, there may be cases where the processing is not completed in time. Therefore, data of a plurality of images having different magnifications is generated from the high resolution captured image data in advance as multi-layer image data. Thus, when a request for changing the display magnification is made, an image data layer having a magnification close to the requested display magnification is selected from among the plurality of image data layers, and resolution conversion is performed on the selected image data layer in accordance with the requested display magnification to generate display data for the virtual slide image. It is desirable in terms of image quality that the display data be generated from image data of higher magnifications.

The layers of the image data are generated by reducing the high resolution captured image by resolution conversion. The method of resolution conversion may be bilinear, which is two-dimensional linear interpolation, or a bicubic using three-dimensional interpolation.

Each layer of the image data has two-dimensional axes, or the X axis and the Y axis. In FIG. 5, the P axis illustrated as an axis oriented perpendicular to the X and Y axes represents the magnification.

In FIG. 5, one layer 502 of the image data is generated from a plurality of divisional image data or image data pieces 505. As described before, high resolution two-dimensional image data is generated by splicing image data pieces obtained by divisional imaging. The divisional image data 505 is image data obtained by capturing an image of an area that can be captured by the imaging sensor 208 at one time. The size of the divisional image data 505 is not limited to this, but the divisional image data 505 may be a section of image data obtained by arbitrarily dividing image data obtained by capturing an image of an area that can be captured by the imaging sensor 208 at one time or image data obtained by joining an arbitrary number of the image data pieces each obtained by capturing an image of an area that can be captured by the imaging sensor 208 at one time.

As described above, it is desirable that the image data for pathologic diagnosis intended to be observed at various display magnifications by enlargement and reduction be generated and stored as image data having multi-layer structure made up of a plurality of image data layers having different magnifications as shown in FIG. 5. The form of image data as such may be single image data in which a plurality of layers of image data are integrated so that the image data can be treated as single image data. Alternatively, the image data may be prepared in a form in which each of layers of image data are prepared as independent pieces of image data, and information specifying the relationship between the pieces of image data and the display magnifications may be stored separately. In the following description, it is assumed that single image data made up of a plurality of layers of image data is prepared.

### (Method of Attaching and Presenting Annotation)

A process of attaching and presenting an annotation in the image processing apparatus according to the present invention will be described with reference to the flow chart in FIG. 6.

In step S601, the display apparatus information obtaining unit 304 obtains information about the size (the screen resolution and the number of pixels) of the display area of the display apparatus 103 and information about the display magnification of the virtual slide image presently displayed. The information about the display area size is used by the display data generating unit 310 to determine the size (the number of pixels) of display data to be generated. The information about the display magnification is used by the image data layer retrieving unit 309 to choose a layer of image data from the memory 302 and also used by the link information generating unit 305 to generate link information for an annotation. The generation of the link information will be described later.

In step S602, the image data layer retrieving unit 309 retrieves a layer of image data corresponding to the display magnification of the virtual slide image presently displayed on the display apparatus 103 from the memory 302. A layer of image data corresponding to a specified magnification may be retrieved.

In step S603, the display data generating unit 310 generates display data to be output to the display apparatus 103 based on the layer of image data retrieved by the image data layer retrieving unit 309. If the display magnification of the virtual slide image designated by the user is different from the magnification of the retrieved image data layer, resolution conversion processing is performed. The display data thus generated is output to the display apparatus 103 and an image is displayed on the display apparatus 103 based on the display data.

In step S604, the display data generation control unit 307 makes a determination as to whether or not a command for changing the display state of the virtual slide image is input by the user, based on information obtained from the user input information obtaining unit 303. Specifically, such commands include a command for shifting the display position (scroll) and a command for changing the display magnification. The command for shifting the display position is, in particular, such a command that makes the display area of the virtual slide image after the shift of the display position fall out of the area covered by the present virtual slide image. If a command for changing the display state is input to require updating of the virtual slide image, the display data generating unit 307 returns to step S602. Thereafter, the processing of retrieving a layer of image data and the processing of updating the virtual slide image by generating display data are performed again. If a command for changing the display state is not input, the display data generation control unit 307 proceeds to step S605.

In step S605, the display data generation control unit 307 makes a determination as to whether or not a command for attaching an annotation is input by the user, based on information obtained through the user input information obtaining unit 303. If a command for attaching an annotation is input, the display data generation control unit 307 proceeds to step S606. If a command for attaching an annotation is not input, the display data generation control unit 307 proceeds to step S607.

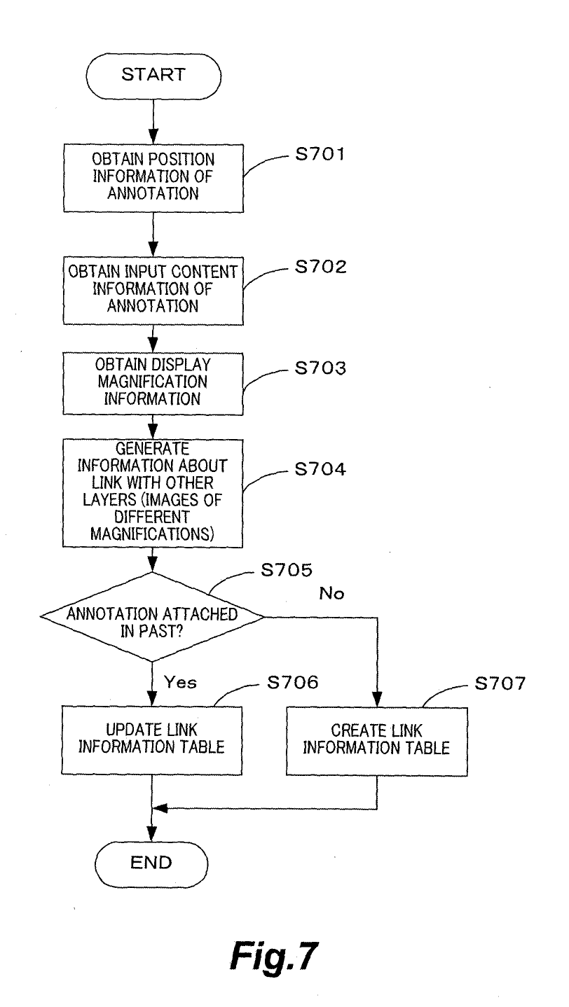

In step S606, various processing for attaching an annotation to the image data is performed. The processing includes obtaining annotation information (the content of the annotation and position information input through the input device such as the keyboard 410) by the user input information obtaining unit 303 and generating link information by the link information generating unit 305. Such processing will be specifically described later with reference to FIG. 7.

In step S607, the display data generation control unit 307 makes a determination as to whether or not a request for presentation of attached annotations is input. If a request for presentation of annotations is input, the display data generation control unit 307 proceeds to step S608. If a request for presentation of annotations is not input, the display data generation control unit 307 returns to step S604 and performs the above-described processing again. While the processing has been described in a chronological order for the sake of explanation, the reception of a request for changing the display position and/or display magnification, the attachment of an annotation, and the presentation of annotations may be performed simultaneously or sequentially in an order different from that described above.

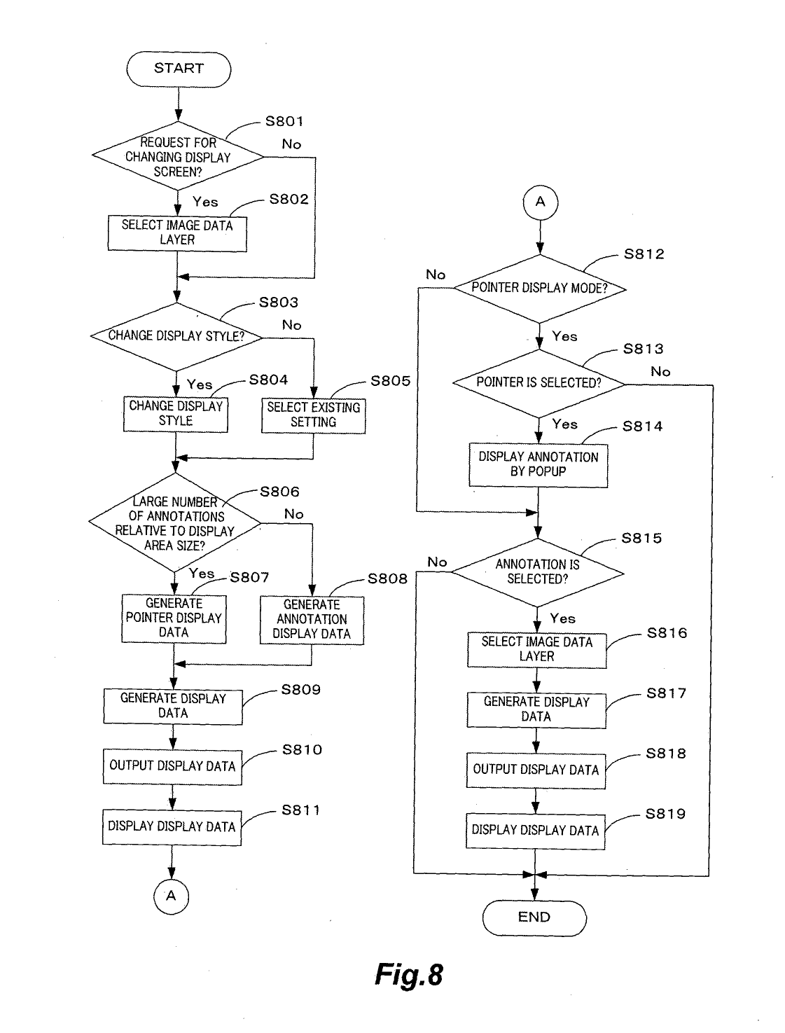

In step S608, the display data generation control unit 307 performs processing of presenting annotations in response to a request for presentation of annotations. This processing will be specifically described later with reference to FIG. 8.

### (Attachment of Annotation)

FIG. 7 is a flow chart specifically describing the process of attaching an annotation in the above-described step S606 in FIG. 6. With reference to FIG. 7, the process of generating link information based on position information of the attached annotation and the display magnification of the virtual slide image at the time of attachment of the annotation will be described.

In step S701, the display data generation control unit 307 obtains the position information of the attached annotation. The display data generation control unit 307 performs processing of converting the relative position of the annotation in the virtual slide image presently displayed into a position in the entire area of the image data, thereby obtaining absolute position information (coordinates) of the annotation.

In step S702, the display data generation control unit 307 obtains content information of the annotation input through the keyboard 410 or other device. The annotation content information thus obtained is used when presenting the annotation.

In step S703, the display data generation control unit 307 obtains information about the display magnification of the virtual slide image displayed on the display apparatus 103. This display magnification is the display magnification at the time of attachment of the annotation. In the illustrative case described in this embodiment, the display data generation control unit 307 obtains the display magnification information from the display apparatus 103. However, because the display data is generated by the image processing apparatus 102, the image processing apparatus 102 may be configured to obtain information about the display magnification that is stored in it.

In step S704, the link information generating unit 305 generates link information based on the position information of the annotation obtained in step S701 and the information about the display magnification at the time of attachment of the annotation obtained in step S703. Since the position (coordinates) of the annotation in image data layers having magnifications different from the magnification at the time of attachment of the annotation can be determined by referring to the link information, the annotation information attached in step S701 can be utilized with any image data layer. For instance, an exemplary case in which an annotation is attached at a position of coordinates (100, 100) in a virtual slide image having a display magnification of 20× is considered. The position of coordinates (100, 100) is at a point having a distance (in the number of pixels) of 100 pixels along the X and Y axes from the point of origin (0, 0) of the entire area of the virtual slide image. This position of the annotation is expressed in a high magnification image having a display magnification of 40× by coordinates P1 (200, 200) and expressed in a low magnification image having a display magnification of 10× by coordinates P2 (50, 50). The coordinates of the position of the annotation in an image data layer having a certain display magnification are obtained by multiplying the coordinates of the annotation at the time of attachment of the annotation obtained in step S701 by the ratio of that display magnification and the display magnification at the time of attachment of the annotation obtained in step S703.

In step S705, a determination is made as to whether or not it is the first attachment of annotation since the start of observation of the virtual slide image. If it is the first attachment, the process proceeds to step S707. On the hand, if attachment of annotation has been performed before at least once, the process proceeds to step S706.

In step S706, the link information stored in the link information table is updated using the link information generated in step S704. The link information table will be described later. Specifically, values in the table for storing link information created at the time when attachment of annotation was performed for the first time, which will be described below in connection with step S707, are updated.

In step S707, the link information table is created. The link information table stores the link information generated in step S704. The link information is information about the association between the position information of the attached annotation, the converted position information obtained by converting the aforementioned position information for image data layers of a plurality of different magnifications, and the display magnification at the time of attachment of the annotation. In the illustrative case described here, it is assumed that the text content of the annotation is also contained in the link information. The link information is information associating the annotation information with the position at which the annotation is to be displayed in a superimposed manner in each image layer, which is calculated based on the display magnification and the position in the image at the time of attachment of the annotation and the display magnification corresponding to the resolution of each image layer.

### (Presentation of Annotation)

FIG. 8 is a flow chart specifically describing a process of presenting the annotation. With reference to FIG. 8, a process of generating display data for presenting the annotation based on the link information will be described.

In step S801, the display data generation control unit 307 makes a determination as to whether or not a request for changing the display state (shifting the display position and/or changing the magnification) of the virtual slide image is made by a user. Screening is generally performed at a display magnification in the range of 5× to 10×, and detailed observation is generally performed at a display magnification of 20× or 40×. Thus, the display magnification of the virtual slide at the time when annotations are attached may vary among the annotations. Therefore, the display magnification that is suitable for survey of the positions of a plurality of annotations attached to image data depends on the plurality of annotations attached to the image data. In step S801, the user can make a request for changing the display state of the virtual slide image into a state suitable for the presentation of the plurality of annotations attached to the image data. If a request for changing the display state is made, the display data generation control unit 307 proceeds to step S802. If a request for changing the display state is not made, the display data generation control unit 307 proceeds to step S803.

In step S802, in response to the request for changing the display state, the display data generation control unit 307 selects an appropriate image data layer so as to achieve a display state of the virtual slide image suitable for the presentation of the annotation. In cases where a plurality of annotations are attached to the image data, the display data generation control unit 307 determines a displayed region in which the positions of all of the plurality of annotations are included so that the positions of all of the annotations attached to the image data can be displayed in the virtual slide image. Then, the display data generation control unit 307 selects an image data layer suitable for the display area thus determined. For instance, if the positions of the annotations are distributed so widely that a virtual slide image having a magnification of 40× cannot cover an area large enough to include the positions of all the annotations, the display data generation control unit 307 selects the image data layer having a magnification of 20× in order to generate display data for a virtual slide image having a display magnification of 20×.

In step 803, the display data generation control unit 307 makes a determination as to whether a command for changing the annotation display style is input or not. The annotation display style includes settings of the decoration of text, the color of the frame image, and the degree of transparency in relation to the background image in presenting the annotations. For example, in a case where the display magnification of the virtual slide image at the time of presentation of an annotation and the display magnification of the virtual slide image at the time of attachment of the annotation are different, the mode of display such as the color and/or font of the text and the color of the frame image can be set in such a way as to indicate that fact. This will be specifically described later. If a command for changing the annotation display style is input, the display data generation control unit 307 proceeds to step S804. If not, the display data generation control unit 307 proceeds to step S805.

In step S804, the display data generation control unit 307 changes the annotation display style in accordance with the input request for changing the style of annotation display.

In step S805, since a request for changing the annotation display style is not input, the display data generation control unit 307 uses a predetermined initial setting of the annotation display style as the setting of the annotation display style.

In step S806, the display data generation control unit 307 makes a determination as to whether or not the number of annotations to be presented is excessively large in relation to the size of the display area of the virtual slide image. The display data generation control unit 307 calculates the proportion of the size of the display area for the annotations to the size of the display area of the virtual slide image in the case where all the annotations are displayed on the virtual slide image according to the display style determined in step S804 or S805. If this proportion is larger than a threshold value, the display data generation control unit 307 determines that the number of annotations is too large. If the number of annotations is too large, displaying all the annotations causes the virtual slide image in the background of the annotations to be covered with the annotations, making the observation of the virtual slide image difficult. The user can freely set the threshold value used in this determination considering to what degree of coverage with the annotations will not interfere with the observation of the virtual slide image. If it is determined that the number of annotations is too large, the display data generation control unit 307 presents the annotations in a pointer display mode. The pointer display mode is a mode in which only the position information of the annotations is displayed on the virtual slide image using icons or the like without displaying the text content of the annotations or frame images. In the pointer display mode, the text content of the annotation is displayed, for example, only for a specific annotation selected by the user. On the other hand, if it is not determined that the number of annotations is too large, the display data generation control unit 307 presents the annotations in an annotation display mode. The annotation display mode is a mode in which the position information and the content information of the annotation are displayed for all the annotations using icons, text, and frame images etc. The apparatus may be configured to allow the user to select whether or not to enable switching between the pointer display mode and the annotation display mode based on the number of annotations.

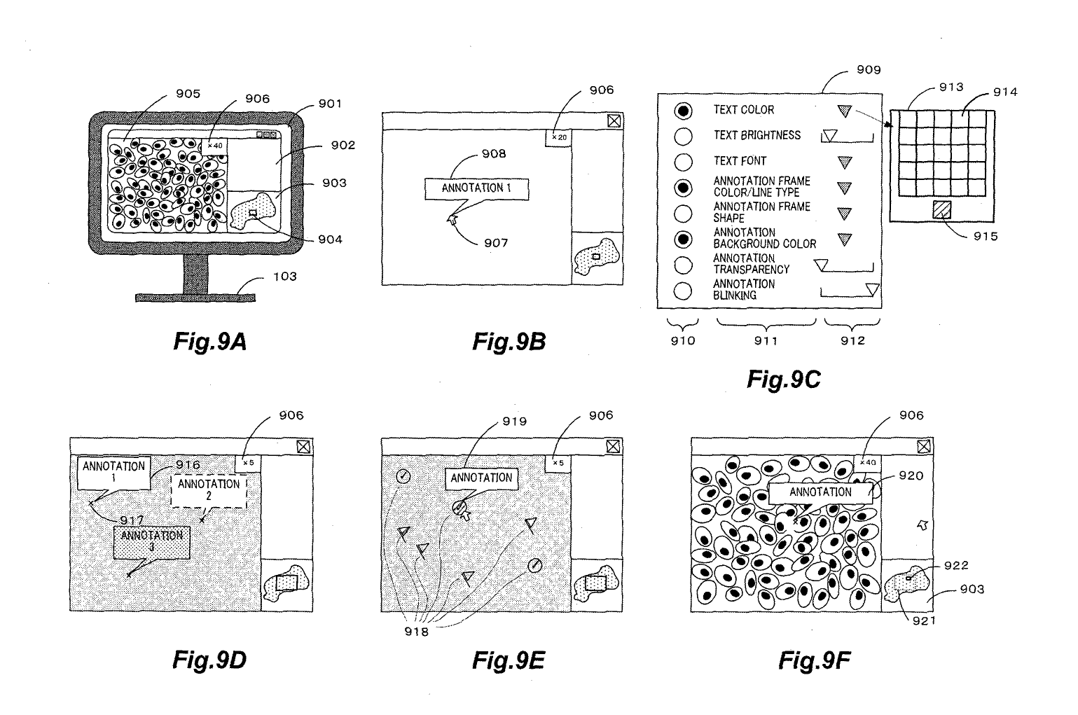

In step S807, the annotation data generating unit 308 generates annotation display data to be used to present the annotations in the pointer display mode. An example of the displayed virtual slide image in which the annotations are presented in the pointer display mode will be described later with reference to FIG. 9E.

In step S808, the annotation data generating unit 308 generates annotation display data to be used to present the annotations in the annotation display mode. An example of the displayed virtual slide image in which the annotations are presented in the annotation display mode will be described later with reference to FIG. 9D.

In step S809, the display data generating unit 310 generates display data of the virtual slide image based on the image data layer selected in step S802 and the annotation display data generated in step S807 or S808.

In step S810, the display data output unit 311 outputs the display data generated in step S809 to the display apparatus 103.

In step S811, the display apparatus 103 displays an image based on the display data output from the display data output unit 311.

In step S812, the display data generation control unit 307 makes a determination as to whether or not the mode of presentation of the annotations is the pointer display mode. If the mode is the pointer display mode, the display data generation control unit 307 proceeds to step S813. On the other hand, if the mode is the annotation display mode, the display data generation control unit 307 proceeds to step S815.

In step S813, the display data generation control unit 307 makes a determination as to whether or not a pointer indicating the position of an annotation displayed on the virtual slide image is selected by the user using the mouse or keyboard or the mouse cursor is placed over such a pointer by the user. If a pointer indicating the position of an annotation is selected or the mouse cursor is placed over such a pointer, the display data generation control unit 307 proceeds to step S814. If not, the display data generation control unit 307 terminates the processing for presenting the annotations.

In step S814, the display data generation control unit 307 generates display data with which the text content of the annotation attached at the position of the selected pointer is displayed in a pop-up box. In the pointer display mode, if the selection of the pointer is cancelled or the mouse cursor is moved away from the pointer, the display data generation control unit 307 generates annotation display data with which the pop-up display of the content of the annotation is deleted. Alternatively, the apparatus may be configured to continuously keep the display of the content of the annotation once a pointer is selected, until a command for deleting the annotation display is input.

In step S815, the display data generation control unit 307 makes a determination as to whether or not an annotation displayed on the virtual slide image is selected by the user using the mouse or keyboard. If the annotation is selected, the display data generation control unit 307 generates, in the subsequent processing, display data with which the display magnification and the display position of the virtual slide image at the time of attachment of the selected annotation is reproduced. If an annotation is selected on the virtual slide image, the display data generation control unit 307 proceeds to step S816. If an annotation is not selected, the process of presenting the annotations is terminated.

In step S816, the image data layer retrieving unit 309 selects an image data layer based on the position information and the information about the display magnification at the time of attachment of the annotation contained in the link information.

In step S817, the display data generating unit 310 generates display data using annotation display data generated by the annotation data generating unit 308 for the annotation selected in step S815 and image data layer selected in step S816.

The process of outputting the display data in step S818 and the process of displaying an image by the display apparatus 103 based on the display data in step S819 are the same as those in steps S810 and S811 respectively.

### (Display Screen Layout)

FIG. 9 shows examples of display of the display data generated in the image processing apparatus 102 on the display apparatus 103. With reference to FIG. 9, the determination of the annotation display style, the difference between the pointer display mode and the annotation display mode, and the reproduction of the display position and the display magnification at the time of attachment of annotations will be described.

FIG. 9A shows the basic configuration (or layout) of the window of the viewer of the virtual slide image displayed on the display apparatus 103. The window of the viewer has an information area 902 showing the status of display and operation and various information about the image and a thumbnail image 903 generally showing the overall image of the specimen to be observed, which are arranged in the overall window 901. In the overall window 901, there also are a frame 904 indicating the displayed region of the virtual slide image in the thumbnail image, a display area 905 for the virtual slide image, and a display 906 of information of the display magnification of the virtual slide image displayed in the display area 905. The window configuration of the viewer may be either a single document interface in which windows displaying various images and information are arranged in the overall window 901 or a multi-document interface including independent windows displaying various images and information respectively. In the thumbnail image 903, there is displayed the frame 904 indicating the position and the size of the region displayed as the virtual slide image in the display area 905 in the full image of the specimen. The position and the size of the frame 904 can be changed by user's instructions input using an input device such as the mouse or the keyboard. The position and the size of the frame 904 are changed in conjunction with user's operations for changing the display region displayed as the virtual slide image in the display area 905 (i.e. for shifting the display position and/or changing the display magnification). In the display area 905, the virtual slide image is displayed. The user conducts a diagnosis or attaches an annotation while observing this virtual slide image. The user can change the display state of the virtual slide image by inputting instructions for changing the display position (shifting the displayed region) and/or instructions for changing the display magnification (enlarging/reducing) by operating the mouse or keyboard so that a virtual slide image suitable for observation is displayed.

FIG. 9B shows an example of screen display on which an operation of attaching an annotation is performed. In the illustrative case shown in FIG. 9B, the display magnification 906 is set to 20×. The user designates a region of interest (or a focused-upon region) in the virtual slide image in the display area 905 and input annotation information. Thus, an annotation is attached. The operation and process for attaching an annotation is basically as follows. A description will be made with reference to FIG. 9B. Firstly, the user manipulates the mouse or the like to designate a position 907 at which an annotation is to be attached. This operation causes the mode to shift to a mode allowing input of the annotation content (text). Then, the user operates the keyboard or the like to input the annotation content (text) 908. At that time, the image processing apparatus 102 obtains information about the position at which the annotation is attached and information about the display magnification of the virtual slide image to which the annotation is attached, in combination.

FIG. 9C shows an example of a screen display with which the annotation display style is set. The screen 909 for setting the annotation display style may be adapted to be displayed at the time of attaching an annotation. Alternatively, the setting screen 909 may be adapted to be displayed when called from a menu in advance or at an appropriate time. In the illustrative case described here, it is assumed that the screen 909 for setting the annotation display style is displayed in the information area 902 shown in FIG. 9A only when the user conducts the operation of attaching an annotation. The annotation display style is the visual style of presentation of the annotation. In this embodiment, the annotation display style can be varied depending on the magnification of the virtual slide at the time of attachment of an annotation or on the difference between the magnification of the virtual slide image at the time of attachment of the annotation and the magnification of the virtual slide image at the time of presentation of the annotation. In this embodiment, three items of setting of the annotation display style including the annotation content (text) display style, the annotation frame display style, and the overall annotation display style will be described by way of example. However, the present invention is not limited to this. The setting items of the annotation content (text) display style include the text color, brightness, font type, and font emphasis (e.g. bold and italic) etc. The setting items of the annotation frame display style include the frame color, frame line type (e.g. solid line/broken line), frame shape (e.g. text balloon, rectangular, and others), and background color. The items of the overall annotation display style include the degree of transparency in the case where alpha-blending is applied to the virtual slide image constituting the background and the blinking frequency in the case where the annotation is displayed in a blinking manner.

GUI parts 910 are check boxes allowing the user to choose a display style he/she likes from among a plurality of display styles. GUI parts 911 describe the names of the setting items of the annotation display style. GUI parts 912 include a button used to open a color setting window 913 in which a plurality of color patches 914 and a selected display color 915 are displayed and sliders used to change the value of the brightness and the value of the degree of transparency. For example, in a case where the brightness of the text can be set by an 8-bit value, a brightness value of 0 to 255 can be set in accordance with the slider position. A GUI part that allows direct number input for setting the brightness value may be displayed, though such a GUI part is not shown in FIG. 9.

FIG. 9D shows an example of screen display in the case where the annotations are displayed in the annotation display mode. In the annotation display mode, each annotation is presented by an icon 917 indicating the position of the annotation and an image 916 the text content of the annotation, a text balloon, and a frame. FIG. 9D shows an illustrative case in which three annotations are presented. If the positions at which the annotations are attached are distributed over a wide range of area, the display magnification may be changed so that the positions of all the annotations can be displayed. The change of the display magnification may be effected automatically based on the position information of the annotations. Alternatively, the user may manually change the display range and the display magnification. In the illustrative case shown in FIG. 9D, the display magnification is 5×. It is assumed that the display magnifications of the virtual slide image at the time of attachment of the respective annotations were different from each other. For example, it is assumed that annotation 1 was attached to the virtual slide image displayed at a display magnification of 10×, annotation 2 was attached to the virtual slide image displayed at a display magnification of 20×, and annotation 3 was attached to the virtual slide image displayed at a display magnification of 40×. In this embodiment, modes of the text balloon and the frame of the annotations are varied according to the display magnifications of the virtual slide image at the time of attachment of the annotations. Thus, the user can recognize the fact that the display magnifications at the time of attachment of the respective annotations were different from each other.

FIG. 9E shows an example of screen display in the case where the annotations are displayed in the pointer display mode. In the pointer display mode, the annotations are presented by icons 918 indicating the position of the annotations. If one of the icons 918 indicating the position is selected or moused over, the annotation content corresponding to the icon is displayed in a popup 919 as shown in FIG. 9E. FIG. 9E shows an exemplary case in which seven annotations are presented. For some of the annotations, the display magnifications of the virtual slide image at the time of attachment thereof are different, while for the other annotations, the display magnifications of the virtual image at the time of attachment thereof are the same. In this embodiment, the modes of the icons 918 indicating the position of the annotations are varied according to the magnifications of the virtual slide image at the time of attachment of the annotations as shown in FIG. 9E. Thus, the user can know whether the display magnifications at the time of attachment of annotations are different or the same from the difference of the icons 918 indicating the position of the annotations. The mode of the popup 919 that is displayed when an icon 918 indicating the position is selected or moused over is also varied according to the display magnification of the virtual slide image at the time of attachment of the annotation, as with that in FIG. 9D. Thus, the user can easily select a desired annotation(s) from among a number of annotations.

FIG. 9F shows an example of screen display in which the position of an annotation and the display magnification in the virtual slide image at the time of attachment of the annotation are reproduced. When one of the annotations is selected by the user in the annotation display mode or the pointer display mode, the display data generation control unit 307 executes the following processing. The display data generation control unit 307 generates, with reference to the link information, display data with which the magnification of the virtual slide image and the position of the annotation in the image at the time when the annotation was attached is reproduced. In the thumbnail display area 903, a frame 921 indicating a region in which the position information of all the annotations shown in FIG. 9D or 9E can be displayed and a frame 922 indicating the region corresponding to the virtual slide image presently displayed are displayed.

### Advantageous Effects of the Embodiment

In this embodiment, when an annotation is attached to a virtual slide image, link information is generated based on position information of the annotation and information about the magnification of the virtual slide image. The link information is generated for each of the attached annotations. The link information is information representing the association between information of each of a plurality of image data layers having different magnifications making up the image data and converted position information representing positions in the respective image data layers corresponding to the position of the annotation. When a plurality of annotations attached to the image data are presented, the modes of display of the annotations are varied according to the display magnifications of the virtual slide image at the time of attachment of the annotations. Thus, the user can easily recognize differences in the magnification of the virtual slide image at the time of attachment of the annotations among the annotations.

### Second Embodiment

An image processing system according to a second embodiment of the present invention will be described with reference to the drawings.

In the second embodiment, an illustrative system in which a plurality of annotations attached to image data made up of a plurality of image data layers having different focus positions are presented in such a manner that enables the user to recognize differences in the focus positions of the virtual slide image at the time of attachment of the annotations. In the following, features different from the first embodiment will be described. Features same as those in the first embodiment will be designated by the same reference signs and referred to by the same names, and will not be described in further detail.

### (Configuration of Apparatuses in Image Processing System)

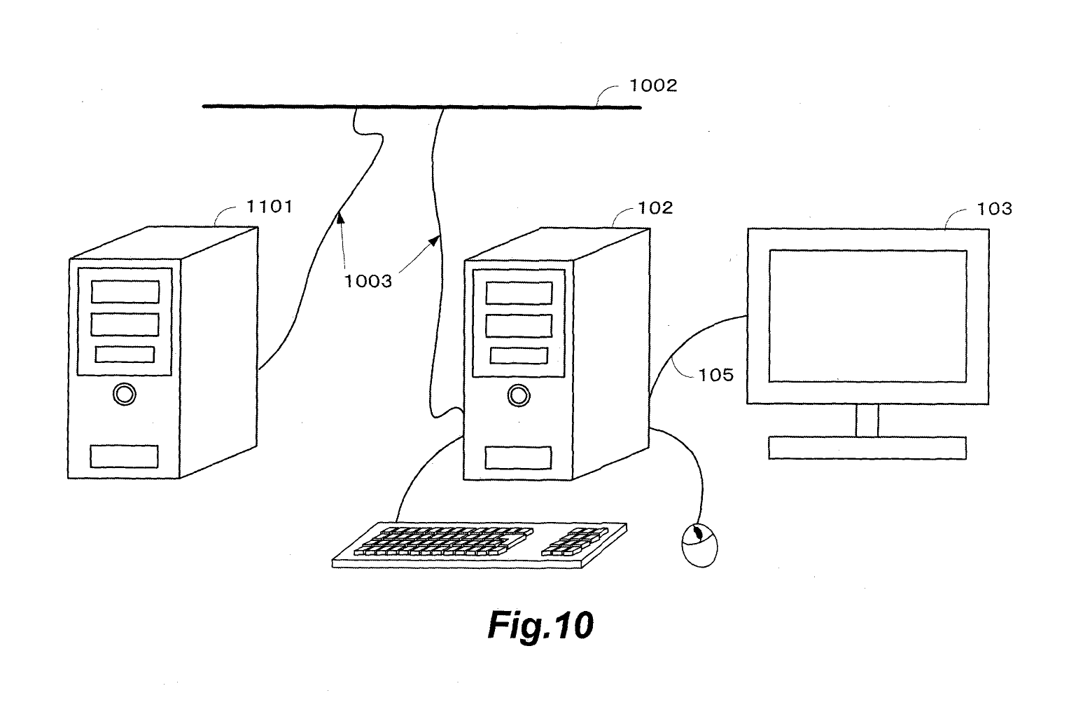

FIG. 10 is an overall view of the apparatuses making up the image processing system according to the second embodiment of the present invention.

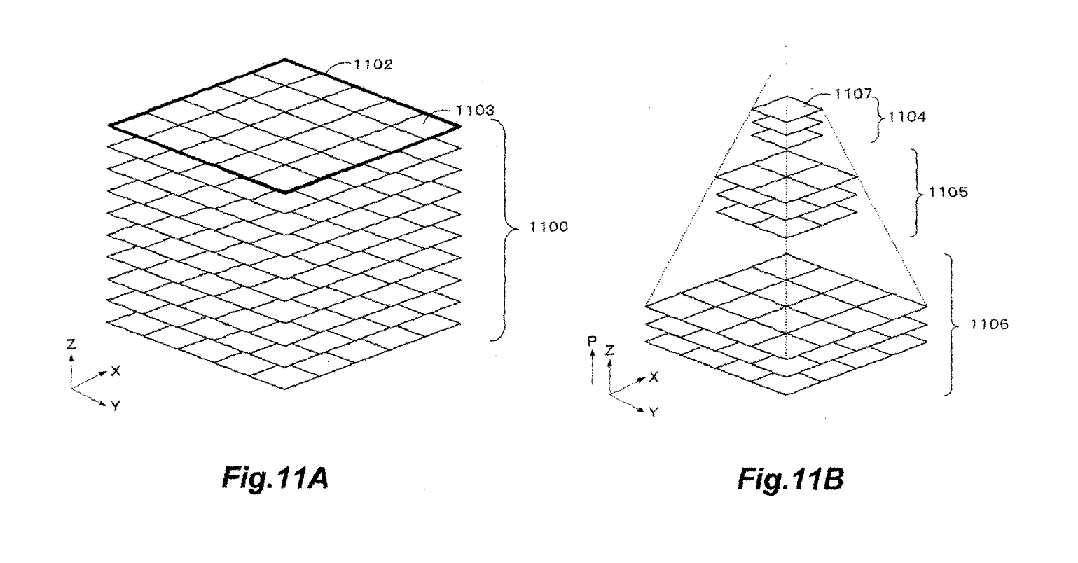

In FIG. 10, the image processing system using an image processing apparatus according to the present invention includes an image server 1101, an image processing apparatus 102, and a display apparatus 103. The image processing apparatus 102 can obtain image data obtained by capturing an image of a specimen from the image server 1101 and generate display image for displaying an image on the display apparatus 103. The image data mentioned here includes high-resolution, two-dimensional image data generated by joining together pieces of captured image data obtained by divisional imaging described in the description of the first embodiment, a plurality of layers of image data having different magnifications prepared for high-speed display, and pieces of depth image data captured at different focus positions. The depth image data will be specifically described later with reference to FIG. 11. The image server 1101 and the image processing apparatus 102 are interconnected by a general-purpose interface LAN cable 1003 through a network 1002. The image server 1101 is a computer equipped with a large-capacity storage device that stores image data captured by an imaging apparatus, which is a virtual slide apparatus (not shown and similar to the imaging apparatus 101 in the first embodiment). The image server 1101 may be configured to store multi-layer image data of different focus positions (depth image data) as single data in a local storage connected to the image server 1101. Alternatively, the layers in the depth image data may be separated from each other, and the pieces of the substantial depth image data and reference information for the pieces of the substantial depth image data may be separately stored in a group of servers (cloud servers) existing in the network. It is not necessary for the depth image data be stored in one server, but it may be stored in distributed manner. The image processing apparatus 102 and the display apparatus 103 are the same as those in the image processing system according to the first embodiment.

While the image processing system illustrated in FIG. 10 is made up of three apparatuses including the image server 1101, the image processing apparatus 102, and the image display apparatus 103, the configuration of the system according to the present invention is not limited to this. For example, an image processing apparatus having an integrated display device may be used, or a part of the functions of the image processing apparatus 102 may be implemented in the image server 1101. Conversely, the functions of the image server 1101 and the image processing apparatus 102 may be divided and implemented in a plurality of apparatuses.

### (Concept of Multi-Layer Image Prepared Beforehand for Multiple Focus Positions)

FIG. 11 schematically illustrates the concept of depth image data made up of a plurality of image data layers having different focus positions. By performing image capturing multiple times while moving the stage 202 of the imaging apparatus 101 along the depth direction (that is, Z-direction in FIG. 2, the direction perpendicular to the stage, or the direction of the optical axis), a plurality of pieces of image data having different focus positions are obtained.

FIG. 11A is a schematic diagram illustrating the concept of image data having a multi-layer structure in which layers of two-dimensional image data captured at different focus positions are stacked along the depth direction.

Data of a two-dimensional image 1102 captured at a certain focal plane in a specimen to be observed is referred to as depth image data. An image data group 1100 is made up of a stack of a plurality of layers of depth image data 1102 captured at focus positions different from each other along the depth direction (Z-direction) perpendicular to the two-dimensional plane (XY-plane). In an illustrative case shown in FIG. 11A, the image data is made up of ten layers of depth image data captured at different focus positions.

One layer of depth image data 1102 is made up of a plurality of pieces of divisional image data 1103. As described before, large-size, high-resolution image data is generated by joining together a plurality of pieces of image data obtained by divisional imaging. Each piece of divisional image data 1103 may be image data having a size equal to the image data obtained by divisional imaging, a collection of pieces of image data obtained by divisional imaging, or image data generated by further dividing the image data obtained by divisional imaging. In other words, any desired way of division of the depth image data 1102 may be adopted, and the unit of division may be either the same as or different from the unit of the divisional imaging.

The depth image data of each focus position has two axes or the X and Y axes defining a two-dimensional plane. In addition, the depth image data has a data format in which depth image data having different focus positions with respect to the Z axis direction (i.e. depth direction) perpendicular to the X and Y axes are arranged in layers.

The imaging optical system of the virtual slide apparatus has a large numerical aperture (NA) in order to achieve high resolution, resulting in a small depth of field generally. While the thickness of a specimen to be observed is about 3 to 5 μm in the case of tissue diagnosis and about 100 μm in the case of cell diagnosis, the depth of field is much smaller than them, specifically about 1 μm. Therefore, it is difficult to generate an image in which a specimen is in focus in its entirety. Since even a specimen having a small thickness has a structure such as a cell nuclei inside in some cases, it is needed to observe the specimen with the focus position varied in order to achieve detailed inspection of a specimen. Image data made up of a plurality of pieces of depth image data is obtained and generated with an intension to meet such a need.

Multi-layer image data made up of a combination of a plurality of layers of image data having different magnifications (or resolutions) generated for the purpose of speedup of the display as described in the first embodiment and a plurality of layers of depth image data having different focus positions as described in this embodiment may be generated. Image data having such a configuration will be described with reference to FIG. 11B.

In FIG. 11B, each of depth image data groups 1104, 1105, 1106 is a collection of a plurality of layers of image data having the same magnification and different focus positions. In other words, the image data layers belonging to the same depth image data group have the same magnification and different focus positions, and image data layers belonging to different depth image data groups have magnifications different from each other.

Display image data for the virtual slide image is generated from image data layer having a magnification and a focus position selected from the plurality of layers of image data according to a need.

It is desirable that image data for pathological diagnosis intended to be observed with the focus position varied be generated and stored as image data having a multi-layer structure made up of a plurality of layers of depth image data having different focus positions as shown in FIG. 11. The form of image data as such may be single image data in which a plurality of layers of depth image data are integrated so that the image data can be treated as single image data. Alternatively, the image data may be prepared in a form in which layers of depth image data are prepared as independent pieces of image data respectively, and information specifying the relationship between the pieces of depth image data and the focus positions may be stored separately. In the following description, it is assumed that single image data made up of a plurality of layers of depth image data is prepared.

### (Attachment of Annotation)

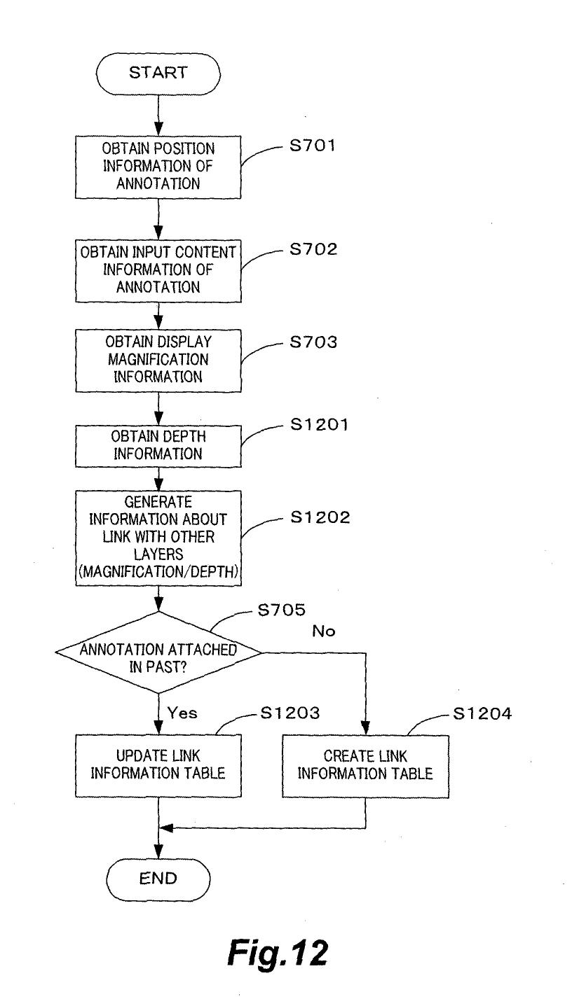

FIG. 12 is a flow chart of a process of attaching an annotation. With reference to FIG. 12, a process of generating link information based on position information of an attached annotation and focus position information of the virtual slide image at the time of attachment of the annotation will be described.

The process of steps 701 to step 703 is the same as that in the process of attaching an annotation described in the first embodiment with reference to FIG. 7, and it will not be described further. The process of step S703 in FIG. 12, in which the display magnification is obtained, is not essential to the configuration of this embodiment and may be skipped.

In step S1201, information about the focus position of the virtual slide image at the time of attachment of the annotation is obtained. The information about the focus position is information indicating from which depth image data layer among the plurality of depth image data layers described with reference to FIG. 11 the display data of the virtual slide image was generated. The information about the focus position may be obtained from the display apparatus 103 as with in the first embodiment, or it may be obtained from information about generation of the display data held in the image processing apparatus 102.

In step S1202, the link information generating unit 305 generates link information based on the focus position information obtained in step S1201 and the position information of the attached annotation obtained in step S701. The link information is information associating converted position information representing positions in the respective depth image data layers making up the image data corresponding to the position represented by the position information of the annotation with the focus positions of the respective image data layers. The link information is generated for each of the annotations attached to the image data. The link information is information associating the positions in the respective depth images at which the annotation is to be displayed in a superimposed manner, which are calculated based on the focus position and the position in the image at the time of attachment of the annotation, with the information of the annotation. In the case where the display magnification information has been obtained in step S703, the link information described in the first embodiment that associates converted position information representing positions in the respective image data layers corresponding to the position represented by the position information of the annotation with the magnifications of the respective image data layers is also generated.

In step S705, a determination is made as to whether or not an annotation has been attached since the start of observation of the virtual slide image. This process is also the same as that in the first embodiment and will not be described further.

In step S1203, the link information stored in the link information table is updated using the link information generated in step S1202.

In step S1204, a link information table is created. In the link information table, the link information generated in step S1202 is stored. The link information is information about the association between the position information of the attached annotation, the converted position information obtained by converting the aforementioned position information for depth image data layers of a plurality of different focus positions, and the focus position at the time of attachment of the annotation. In the case where link information about the association between the position information and the magnification has been generated in step S1202, information about association between the position information of the attached annotation converted for the respective image data layers and the magnifications of the image data layers may be stored additionally.

### (Presentation of Annotation)

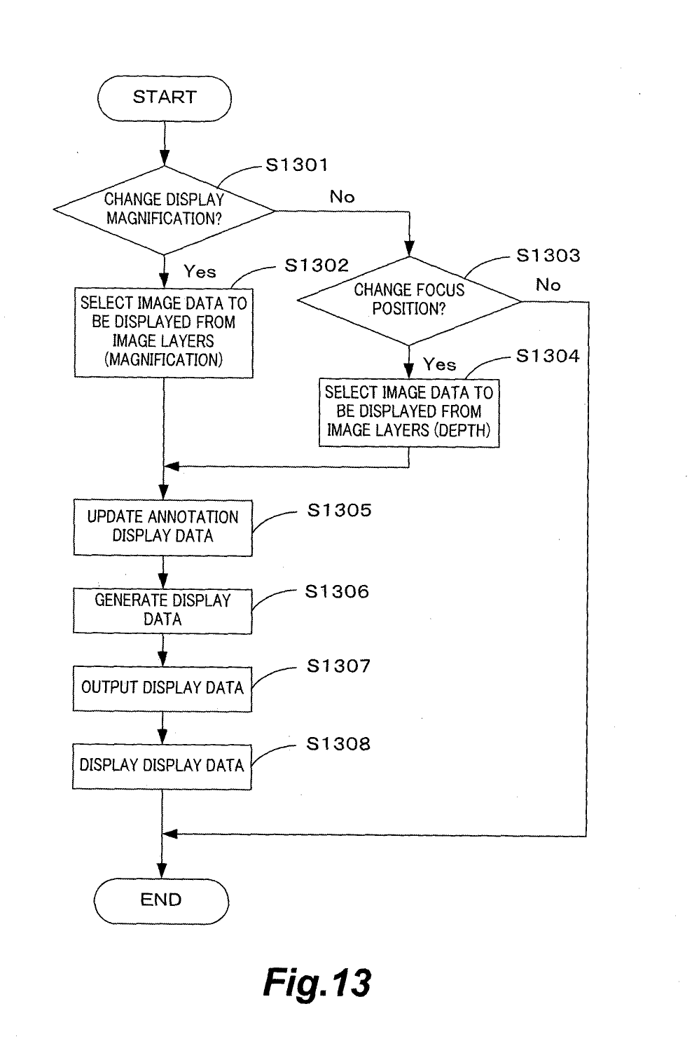

FIG. 13 is a flow chart of a process of presenting the annotations. With reference to FIG. 13, a process of generating display data used to present the annotations based on the link information will be described.

The process of the initial presentation of the annotations is basically the same as the process described in the first embodiment with reference to FIG. 8. What is different is that the selection of display style for indicating a difference in the display magnification is replaced by the selection of display style for indicating a difference in the focus position. In the following, a process of changing the presentation of the annotations in cases where a change in the display magnification and/or a change in the focus position is made after the initial presentation of the annotations will be described. Here, an exemplary case in which image data having a multi-layer structure including a plurality of layers of depth image data having different focus positions and a plurality of layers of image data having different magnifications as illustrated in FIG. 11B is used will be described. In the image display using such image data, the magnification can be changed at high speed during observation of the image (without performing resolution conversion each time the magnification is changed), and the focus position can be changed, both by an operation by the user.

In step S1301, the display data generation control unit 307 makes a determination as to whether or not a request for changing the display magnification is made by the user. If a request for changing the display magnification is made, the display data generation control unit 307 proceeds to step S1302. On the other hand, if a request for changing the display magnification is not made, the display data generation control unit 307 proceeds to step S1303.

In step S1302, the image data layer retrieving unit 309 retrieves an image data layer having a magnification matching the magnification changing request from among the plurality of image data layers.

In step S1303, the display data generation control unit 307 makes a determination as to whether or not a request for changing the focus position is made by the user. If a request for changing the focus position is made, the display data generation control unit 307 proceeds to step S1304. On the other hand, if a request for changing the focus position is not made, the display data generation control unit 307 terminates the process.

In step S1304, the image data layer retrieving unit 309 retrieves an image data layer having a focus position matching the focus position changing request from among the plurality of depth image data layers.

In step S1305, the annotation data generating unit 308 updates the annotation display data. In the annotation display mode, annotation display data with which the positions and contents of the plurality of annotations attached to the image data are displayed in modes varied according to the display magnifications and the focus positions of the virtual slide image at the time of attachment of the annotations is generated. In the pointer display mode, annotation display data with which the positions of the plurality of annotations are displayed in modes varied according to the display magnifications and the focus positions of the virtual slide image at the time of attachment of the annotations is generated. Features of the annotation display data such as the color, brightness, and font of the text, the shape and color of the annotation display frame, the background color in the frame, the degree of transparency of the annotation display area, and use/nonuse of blinking display, are determined according to the annotation display style set by the user.

In step S1306, the display data generating unit 310 generates display data for screen display, from the image data layer selected in step S1302 or the depth image data layer selected in step S1304 and the annotation display data generated in step S1305.

In step S1307, the display data output unit 311 outputs display data generated in step S1306 to the display apparatus 103.

In step S1308, the display apparatus 103 displays an image on the screen based on the display data input from the display data output unit 311.

### Advantageous Effects of the Embodiment

In this embodiment, when an annotation is attached to a virtual slide image, link information is generated based on position information of the annotation and focus position information of the virtual slide image. The link information is generated for each of the attached annotations. The link information is information representing the association between a plurality of depth image data layers having different focus positions making up the image data and converted position information representing positions in the respective depth image data layers corresponding to the position of the annotation. When a plurality of annotations attached to the image data are presented, the modes of display of the annotations are varied according to the focus positions of the virtual slide image at the time of attachment of the annotations. Thus, the user can easily recognize differences in the focus position of the virtual slide image at the time of attachment of the annotations among the annotations.

### Third Embodiment

In the embodiment described in the following, display control is performed using data of an annotation attached to a depth image having a focus position different from the depth image presently displayed, in accordance with the display magnification and the displayed focus position.

In the observation at high magnifications, the depth of field is generally small, and it is necessary in many cases to vary the focus position during observation. Therefore, when the display magnification is higher than a certain magnification, displaying annotations attached to depth images of which the focus position is different from the focus position of the presently displayed depth image will provide information about depth images of shallower and/or deeper focus position(s) without changing the focus position, which will be informative in performing detailed observation.

In this embodiment, the above-described function is carried out by additionally performing an annotation data control process (not shown) in accordance with the display magnification and the displayed focus position just before step S1305 in FIG. 13 described in the second embodiment.

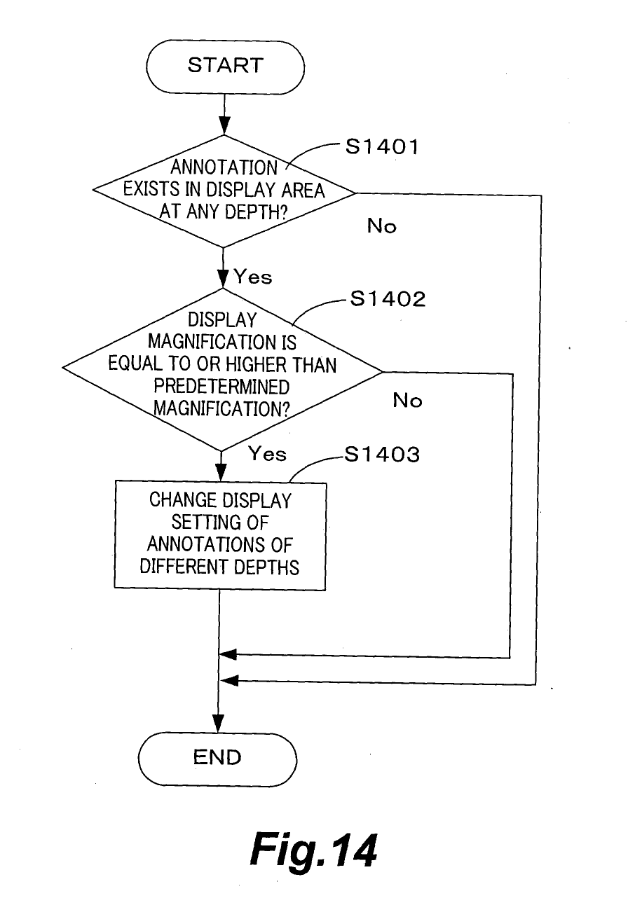

FIG. 14 is a flow chart of a process of controlling the annotation data display in accordance with the display magnification and the displayed focus position.

Firstly in step S1401, the display data generation control unit 307 makes a determination as to whether or not an annotation exists in a depth image of any focus position in the displayed region. If an annotation does not exist, the display data generation control unit 307 terminates the process. On the other hand, if an annotation exists in a depth image of any focus position in the displayed region, the display data generation control unit 307 proceeds to step S1402, where it makes a determination as to whether or not the display magnification is equal to or higher than a predetermined magnification. The predetermined magnification may be set as desired. In the following description of this embodiment, it is assumed that the predetermined magnification is 20×.

If the display magnification is lower than 20×, the display data generation control unit 307 terminates the process. On the other hand, if it is determined in step S1402 that the display magnification is equal to or higher than 20×, the display data generation control unit 307 proceeds to step S1403, where it changes the setting of display of the annotations attached to depth images of focus positions different from the focus position of the presently displayed depth image.

For example, if the current setting is that the annotations attached to the depth images of focus positions different from the focus position of the presently displayed depth image are not displayed, the setting is changed to display also the annotations attached to the depth images of focus positions different from the focus position of the presently displayed depth image. In this changed setting, the annotations attached to the depth images of focus positions different from the focus position of the presently displayed depth image are made visually discernable. For example, the color or the degree of transparency thereof are made different from those of the original annotations (i.e. the annotations attached to the presently displayed depth image).

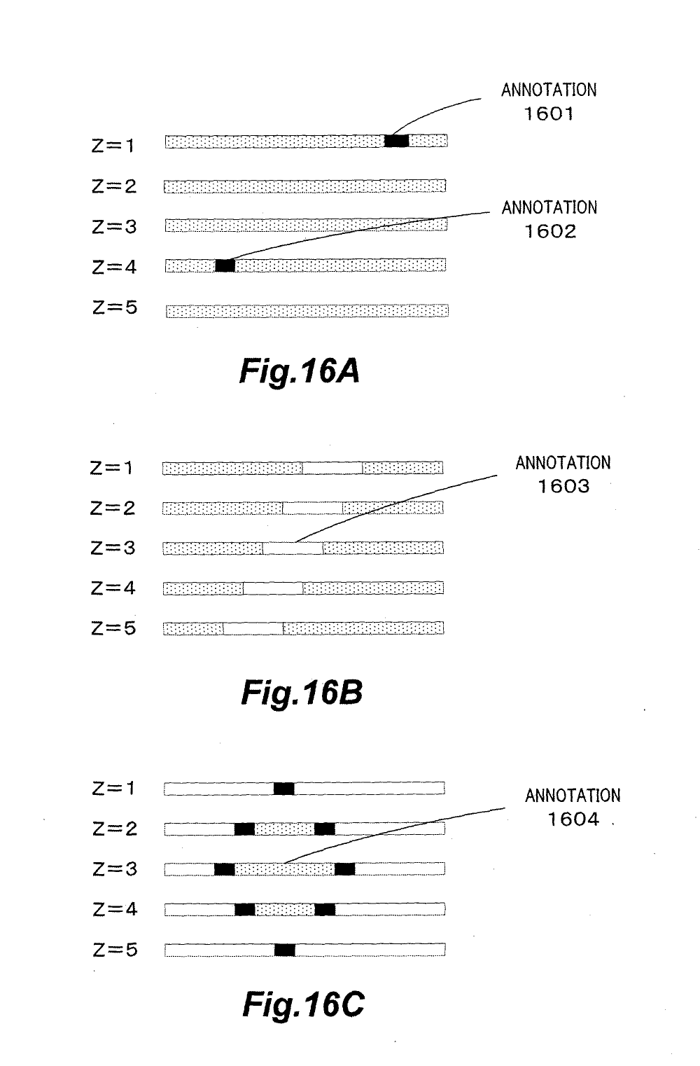

FIG. 16A is a one-dimensional schematic diagram of five depth images having a magnification of 20×. Annotations 1601, 1602 are attached to parts considered to be abnormal in the depth image of Z=1 and the depth image of Z=4 respectively.

When the depth image is observed at a magnification of 20× and at the focus position Z=3, the above-described annotation data display control process is applied. Since the magnification is not lower than 20×, the two annotations in the depth images of Z=1 and Z=4 are determined to be annotations to be displayed though they are annotations attached to depth images of which the focus position is different from the focus position of the presently displayed depth image, and these annotations are displayed.

Thus, even when the depth image of the focus position Z=3 is observed, the content of annotations attached to depth images of deeper and shallower focus positions are displayed. Consequently, the user can know the presence of abnormal parts in the vicinity without changing the focus position and can perform detailed observation deliberately.

On the other hand, when the observation is performed at a magnification of 5× and at the focus position Z=1, since the display magnification is lower than 20×, only the annotation attached to the depth image of the focus position z=1 is displayed. At low magnifications, because the depth of field is large, switching between a plurality of depth images during observation is rarely needed, and it is rarely necessary to change the focus position. Therefore, it is sufficient for the user that the content of only the annotations attached to the depth image of the displayed focus position is displayed.

At high magnifications, the depth of field is small. Then, the annotations to which this process is applied may be not all the annotations attached to the depth images of all the focus positions but only annotations attached to the depth images in a predetermined focus position range in the neighborhood of the focus position of the presently displayed depth image.

As described above, by the process shown in FIG. 14, the display of annotations attached to depth images of focus positions different from the focus position of the presently displayed depth image can be controlled in accordance with the display magnification and the displayed focus position. This advantageously increases the user-friendliness in detailed observation.

### Fourth Embodiment

In the fourth embodiment described in the following, in cases where an annotation is attached to a depth image of which the focus position is different from the focus position of the presently displayed depth image, the display of the annotation is controlled in accordance with the degree of similarity of the image in the area in the neighborhood of the annotation between these depth images.

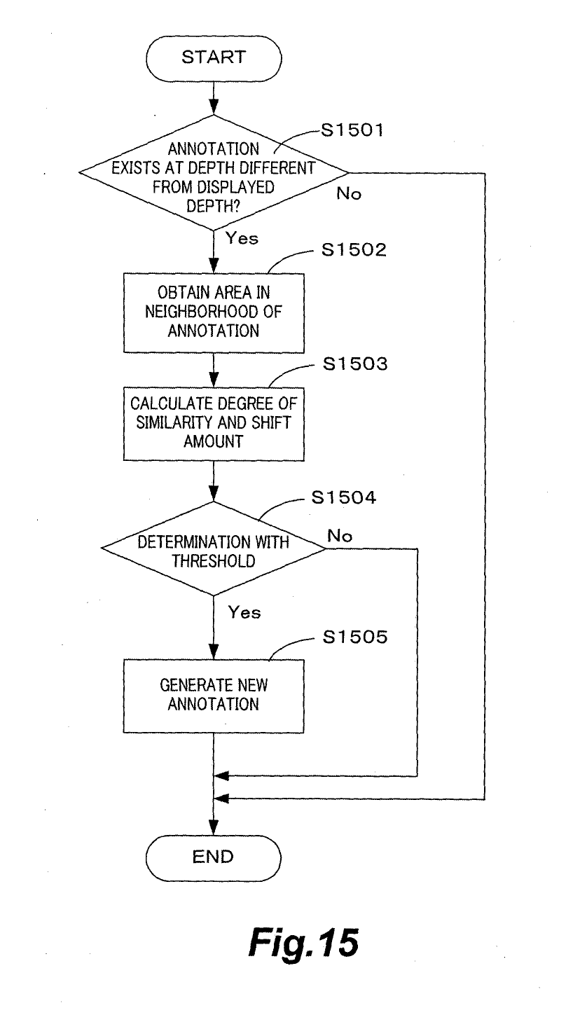

FIG. 15 is a flow chart of annotation data display control in this embodiment.

Firstly in step S1501, the display data generation control unit 307 makes a determination as to whether or not an annotation exists in a depth image of a focus position different from the focus position of the presently displayed depth image. If an annotation does not exist, the display data generation control unit 307 terminates the process. On the other hand, if an annotation exists, the display data generation control unit 307 proceeds to step S1502. In step S1502, the display data generation control unit 307 obtains images of a region in the neighborhood of the position of the annotation in the depth image in which the annotation exists and in the presently displayed image and proceeds to step S1503.

The region of the image in the neighborhood of the position of the annotation may be defined in advance in the annotation. Alternatively, the region of the image in the neighborhood of the position of the annotation may be a predetermined rectangular region at the center of which is the position of the annotation.

Then, in step S1503, the display data generation control unit 307 calculates the degree of similarity between the images of the region in the neighborhood of the position of the annotation in the presently displayed image and in the depth image in which the annotation exists and shifted coordinates. Block matching may be used in calculating the degree of similarity and the shifted coordinates. Block matching is an ordinary method used to determine corresponding positions in different images. Residual sum of square and normalize cross correlation may be used in the internal computation.

The degree of similarity is the largest value of the correlation value of the two images obtained while shifting the image of a region in the neighborhood of the position of the annotation in the depth image in which the annotation exists relative to the image of a region in the neighborhood of the position of the annotation in the presently displayed depth image. The shifted coordinates are coordinates determined based on the shift amount that makes the correlation value largest. By performing matching in a predetermined region in the neighborhood of the position of annotation without performing the calculation of the degree of similarity over the entire display area, processing speed can be made faster.

Then, in step S1504, the display data generation control unit 307 makes a determination as to whether the degree of similarity calculated in step S1503 is equal to or higher than a predetermined threshold value. If the degree of similarity is lower than the threshold value, the display data generation control unit 307 determines that the image in the neighborhood of the position of the annotation in the depth image in which the annotation exists and the image in the neighborhood of the position of the annotation in the presently displayed depth image are different and proceeds to step S1305.

On the other hand, if the degree of similarity is equal to or higher than the threshold value, the display data generation control unit 307 determines that the image in the neighborhood of the position of the annotation in the depth image in which the annotation exists and the image in the neighborhood of the position of the annotation in the presently displayed depth image are substantially identical and proceeds to step S1505.

In step S1505, information of a new annotation to be attached to the presently displayed depth image is generated.

The position of the new annotation is set to the position of the shifted coordinates obtained in step S1503. The comments in the annotation are left unchanged.

It is preferred that the new annotation be displayed in a mode different from the original annotation(s) to indicate the fact that the new annotation is an annotation presumptively introduced based on image processing. For example, the color or the degree of transparency of the annotation may be made different. Moreover, information about the aforementioned degree of similarity may be additionally included in the annotation to inform the user of the degree of similarity.

Displaying annotation information attached to a depth image of a focus position shallower or deeper than the displayed focus position with an appropriate positional shift can save the user the trouble of changing the focus position to check annotations during the observation, as with in the third embodiment. Furthermore, the user can save the trouble of attaching annotations at a plurality of focus positions.

In the following, a few exemplary results obtained by the processing described with reference to the flow chart of FIG. 15 will be described with reference to schematic diagrams in FIG. 16.

FIG. 16B shows exemplary image data made up of depth image data layers of five focus positions. An annotation 1603 is attached to the depth image of the focus position Z=3. It is assumed that the part to which the annotation is attached is a cavity in the sample tissue.

In the case where the displayed focus position is the position Z=1, although a cavity is not present at the X-Y position same as the position of the cavity in the depth image of the focus position Z=3, a similar cavity is also present at a shifted position. Therefore, in the above-described annotation data control processing, when the depth image of the focus position Z=1 is displayed, a new annotation is created at the shifted coordinates calculated in step S1503. The new annotation is displayed in a mode different from the original annotation 1603 in terms of its color and/or degree of transparency.

FIG. 16C shows exemplary image data made up of depth image data layers of five focus positions. An annotation 1604 is attached to the depth image of the focus position Z=3. It is assumed that the part to which the annotation is attached is a certain structure in the sample tissue.

An image similar to the image representing the structure in the neighborhood of the annotation 1604 does not exist in the depth image of any focus position. Consequently, in the case where the depth image of Z=1 is displayed, the degree of similarity calculated in step S1503 does not become equal to or higher than the threshold value, and new annotation is not created.

At high magnifications, the depth of field is small. Then, the annotations to which the processing of steps S1501 to S1503 is applied may be not all the annotations existing in the depth images of all the focus positions but only annotations existing in the depth images in a predetermined focus position range in the neighborhood of the focus position of the presently displayed depth image.

With the process shown in FIG. 15, even when an annotation is attached to a depth image of a focus position different from the focus position of the displayed image, the annotation attached to the depth image of the different focus position can be displayed if the images in a region in the neighborhood of the annotation in both the depth images are similar to each other. This advantageously increases the user-friendliness in observation. In particular, in cases where a difference in the focus position makes the same characteristic structure in tissue appear at different positions in the two-dimensional image due to its configuration, attached annotations can be utilized effectively.

### Other Embodiments

The object of the present invention may be achieved by supplying a non-transitory computer readable recording medium (or a storage medium) in which program code of software that carries out the functions of the above described embodiments entirely or partly is stored to a system or an apparatus and causing a computer (or CPU or MPU) of the system or the apparatus to read and execute the program code stored in the recording medium. In this case, the functions of the above-described embodiments are implemented in the program code read out from the recording medium, and the recording medium in which the program code is recorded constitutes the present invention.

When the computer executes the read-out program code, the operating system (OS) or the like running on the computer may execute all or a part of the actual processing based on instructions by the program code. Cases in which the functions of the above-described embodiments are carried out by such processing can also be included in the scope of the present invention.

Furthermore, the program code read out from the recording medium may be written into an expansion card inserted to the computer or a memory that an expansion unit connected to the computer has. Then, a CPU or the like in the expansion card or the expansion unit may execute all or a part of the actual processing to carry out the functions of the above-described embodiments. Such a case can also be included in the scope of the present invention.

In the case where the present invention is applied to the above-described recording medium, program code corresponding to the flow charts described in the foregoing is stored in the recording medium.

Two or more of the features described in the first, second, third, and fourth embodiments may be adopted in combination. For example, the process of indicating the focus position in the second embodiment may be applied to the system according to the first embodiment. The image processing apparatus may be connected to both the imaging apparatus and the image server so that an image to be processed can be retrieved from either of them. Other arrangements realized by feasible combinations of various technologies used in the above-described embodiments are included in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-283721, filed on Dec. 26, 2011, and Japanese Patent Application No. 2012-221557, filed on Oct. 3, 2012, which are hereby incorporated by reference herein in their entirety.

1. An image processing apparatus comprising:
an obtaining unit configured to obtain data of an image of an object and data of a plurality of annotations attached to the image;
an input unit configured to receive a designation of a display magnification for enlarging or reducing the image; and
a generation unit configured to generate display data with which the annotations are displayed in such a way as to be superimposed on the image enlarged at the designated display magnification,
wherein the data of the plurality of annotations includes position information indicating a position in the image at which each annotation is attached and information about the display magnification of the image at the time of attachment of each annotation, and
the generation unit generates display data with which a display mode of a first annotation which is attached to the image enlarged at a first display magnification and a display mode of a second annotation which is attached to the image enlarged at a second display magnification are different.

2. An image processing apparatus according to claim 1, wherein the generation unit generates display data with which display modes of annotations are made different between an annotation of which the display magnification of the image at the time of attachment thereof and the designated display magnification are different and an annotation of which the display magnification of the image at the time of attachment thereof and the designated display magnification are the same.

3. An image processing apparatus according to claim 1, wherein the input unit receives a command for selecting one of the annotations displayed in such a way as to be superimposed on the image, and when the input unit receives the command for selection, the generation unit generates display data with which the annotation selected by the command is displayed in such a way as to be superimposed on the image enlarged at the display magnification at the time of attachment of the selected annotation.

4. An image processing apparatus according to claim 1, wherein the data of the image obtained by the obtaining unit includes data of a plurality of image layers of the same object having gradually different resolutions, and the generation unit generates display data using the data of an image layer having a resolution suitable for the designated display magnification.

5. An image processing apparatus according to claim 4, further comprising storage unit configured to calculate a position in each image layer at which an annotation is to be displayed in a superimposed manner, based on the display magnification of the image at the time of attachment of the annotation, the position on the image at which the annotation is attached, and the display magnification corresponding to the resolution of each image layer, and configured to store link information in which the calculated position is associated with information of the annotation, wherein the generation unit calculates a position of the annotation associated with the designated display magnification based on the link information and generates display data with which the annotation is displayed in such a way as to be superimposed on the image enlarged at the designated display magnification.

6. An image processing apparatus comprising:
an obtaining unit configured to obtain data of an image of an object including data of a plurality of depth images obtained by imaging the object at different focus positions with respect to the direction of an optical axis, and data of a plurality of annotations attached to the image;
an input unit configured to receive a designation of a focus position; and
a generation unit configured to generate display data with which the annotations are displayed in such a way as to be superimposed on a depth image of the designated focus position,
wherein the data of the plurality of annotations includes position information indicating a position in the image at which each annotation is attached and information about the focus position of the image at the time of attachment of each annotation, and
if an annotation is attached to a depth image of a focus position different from the designated focus position, and the degree of similarity of an image in a neighborhood of a position, which is corresponding to the position of this annotation, in the depth image of the designated focus position and an image in a neighborhood of the position of this annotation in the depth image of a focus position different from the designated focus position is equal to or higher than a threshold value, the generation unit generates display data with which this annotation is displayed in such a way as to be superimposed on the depth image of the designated focus position.

7. An image processing apparatus according to claim 6, wherein the generation unit generates display data with which display modes of annotations are made different between an annotation of which the focus position of the image at the time of attachment thereof and the designated focus position are different and an annotation of which the focus position of the image at the time of attachment thereof and the designated focus position are the same.

8. An image processing apparatus according to claim 7, further comprising storage unit configured to calculate a position in each depth image at which an annotation is to be displayed in a superimposed manner, based on the focus position of the image at the time of attachment of the annotation and the position of the annotation in the image at the time of attachment of the annotation, and configured to store link information in which the calculated position is associated with information of the annotation, wherein the generation unit calculates a position of the annotation associated with the designated focus position based on the link information and generates display data with which the annotation is displayed in such a way as to be superimposed on the depth image of the designated focus position at the calculated position.

9. An image processing apparatus according to claim 6, wherein if an annotation is attached to a depth image of a focus position different from the designated focus position, the generation unit generates display data with which this annotation is displayed in such a way as to be superimposed on the depth image of the designated focus position.

10. An image processing apparatus according to claim 9, wherein the input unit further receives a designation of a display magnification for enlarging or reducing the depth image, and the generation unit generates display data with which the annotation attached to a depth image of a focus position different from the designated focus position is displayed in such a way as to be superimposed on the depth image of the designated focus position, if the display magnification is equal to or higher than a threshold value.

11. An image processing apparatus according to claim 9, wherein the generation unit generates display data with which an annotation attached to the depth image of the designated focus position and the annotation attached to a depth image of a focus position different from the designated focus position are displayed in different display modes.

12. (canceled)

13. An image processing apparatus according to claim 6, wherein the generation unit determines the degree of similarity of the image in the neighborhood of the position, which is corresponding to the position of the annotation, in the depth image of the designated focus position and the image in the neighborhood of the position of the annotation in the depth image of a focus position different from the designated focus position by calculating the correlation of these images while shifting these images relative to each other in a predetermined range and determines a position in the depth image of the designated focus position at which the annotation attached to the depth image of a focus position different from the designated focus position is to be displayed, based on a shift amount that makes the correlation highest.

14. An image processing system comprising:
an image processing apparatus according to claim 1; and
a display apparatus that displays an image based on image data output from the image processing apparatus.

15. A method of controlling an image processing apparatus comprising:
an obtaining step of obtaining data of an image of an object and data of a plurality of annotations attached to the image;
an input step of receiving a designation of a display magnification for enlarging or reducing the image; and
a generation step of generating display data with which the annotations are displayed in such a way as to be superimposed on the image enlarged at the designated display magnification,
wherein the data of the plurality of annotations includes position information indicating a position in the image at which each annotation is attached and information about the display magnification of the image at the time of attachment of each annotation, and
in the generation step, generating of display data with which a display mode of a first annotation which is attached to the image enlarged at a first display magnification and a display mode of a second annotation which is attached to the image enlarged at a second display magnification are different is performed.

16. A method of controlling an image processing apparatus comprising:
an obtaining step of obtaining data of an image of an object including data of a plurality of depth images obtained by imaging the object at different focus positions with respect to the direction of an optical axis, and data of a plurality of annotations attached to the image;
an input step of receiving a designation of a focus position;
a generation step of generating display data with which the annotations are displayed in such a way as to be superimposed on a depth image of the designated focus position,
wherein the data of the plurality of annotations includes position information indicating a position in the image at which each annotation is attached and information about the focus position of the image at the time of attachment of each annotation, and
if an annotation is attached to a depth image of a focus position different from the designated focus position, and the degree of similarity of an image in a neighborhood of a position, which is corresponding to the position of this annotation, in the depth image of the designated focus position and an image in a neighborhood of the position of this annotation in the depth image of a focus position different from the designated focus position is equal to or higher than a threshold value, in the generation step, generating of display data with which this annotation is displayed in such a way as to be superimposed on the depth image of the designated focus position is performed.

17. A non-transitory computer readable storage medium storing a computer program that causes a computer to execute the steps in the method of controlling an image processing apparatus according to claim 15.
